(19) United States
(12) Patent Application Publication
(10) Pub. No.: US 2005/0037787 A1
(43) Pub. Date: Feb. 17, 2005

(54) Wireless intelligent portable-server system (WIPSS)

(75) Inventors: Edward F. Bachner III, Homer Glen, IL (US); Gary L. Dorst, Chicago, IL (US); Charles Keith Campbell, Oak Brook, IL (US); Edward F. Bachner IV, Lake in the Hills, IL (US); Wesley Stuart Jones, Palatine, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Rosett-Wireless Corporation, Oakbrook Terrace, IL (US)

(21) Appl. No.: 10/875,250

(22) Filed: Jun. 24, 2004

Related U.S. Application Data
(60) Provisional application No. 60/482,978, filed on Jun. 27, 2003.

(51) Int. Cl. H04B 15/00

(52) U.S. Cl. 455/502

(57) ABSTRACT

A sync-seeking system comprises a central server and a portable server that include control programs to maintain the equivalency of their stored data and to accumulate additional data from outside sources. The portable server establishes a wireless connection with at least one wireless network, e.g., a wireless wide area network (WWAN) or a wireless local area network (WLAN), and the central server and portable server establish a logical connection via the at least one wireless network. In order to maintain logical equivalency, the central server and portable server intermittently engage in peer-to-peer communication via the logical connection to exchange the additional data they have accumulated. The portable server can be interconnected, via wireless links, to display devices, such as laptop computers, PDAs, set-top boxes, and cell phones.

### CROSS-REFERENCE TO RELATED APPLICATIONS

This application claims priority on U.S. Provisional Patent Application No. 60/482,978, filed Jun. 27, 2003, which application is fully incorporated herein by reference. The embodiments disclosed herein may make use of devices disclosed in U.S. patent application Ser. No. 09/652,734 titled “Wireless Intelligent Personal Server” filed Aug. 31, 2000, which is incorporated herein by reference.

### BACKGROUND

1. Field of the Invention

This invention relates to data communications between digital systems through wireless communications networks. It is an innovative and non-obvious melding of computer technology, RF technology, and data communications technology to solve many crucial problems of wireless information communications. This invention provides a new communications paradigm (called “POST”) to provide ubiquitous information via seamless, secure data transmission through various types of intermittent and sporadic wireless communications channels.

2. Description of Related Art

a. Introduction

The promise of wireless data communication is that it will free the users from being tied down to the office, or having to return as often to their base of operations. Wireless data communications can provide this freedom to that large segment of the workforce that is most productive when the mobile worker remains “in the field.”

In practice, however, given the current state of wireless data communications technology, the data communications capabilities of the office worker (and corresponding efficiency and productivity) vastly outweigh that of the mobile worker. The current limitations with today's state-of-the-art systems, which are addressed with the invention described herein, are many:
1. Difficult RF propagation caused by weak signals and/or multipath and/or interference.
2. Channel-loading caused by traffic peaks, and the resulting latency.
3. High cost of “On-demand” airtime.
4. Time wasted using the problematic “Inquiry/Response” technique of accessing information.
5. Low data throughput provided by WWANs.
6. Security of information in the field.
7. Currency of information in the field.
8. Multiple versions of information on different devices.

b. Current Status of Wireless Data Connections

One commonly hears wireless communication protocols described in terms of the initiation of communication, such as: “Push,” “Pull,” and “Dock.”

“Pull” refers to the inquiry/response method that is common for use with devices such as wireless Palm Pilots, wireless-equipped PocketPCs, Nokia Communicators, and Handspring TREO. The interchange is initiated by the end-user. First of all, one must be connected on an RF basis. Then, a request is entered into the device and transmitted. Because of slow transmission speeds, there is some wait period for transmission and reply, plus processing time on the fixed end. The user must stay connected during this period. Replies are typically short, consistent with the storage memory and display screen limitations on these devices.

Typical problems with Pull-initiated communications are as follows: (1) limited memory and slow transmission speeds focus these devices on simple answers to simple questions; (2) the answers that are received are held in memory without any attempt at security; (3) if used for e-mail, there is no common ‘sent mail’ record (that is, common among a person's other e-mail capable devices); (4) RF reliability and availability; (5) old downloaded information may be used if the owner forgets to request the most resent version of a document; and (6) there is no guaranteed delivery, because the system counts on the user requesting a repeat transmission if the information is garbled.

“Push” refers to one-way communications initiated by the fixed end equipment. Commonly used devices include the RIM Blackberry and the Motorola PageWriter, and are principally used for e-mail. The advantage over Pull devices is that the user does not have to find a location with suitable RF coverage; the system keeps trying to contact his device, and when it does it ‘pushes’ information out to the device. A Push system works best when the target device is always turned on, which may present battery life challenges.

The major challenge for Push technologies is that the device may not be appropriate for the information being sent to it. The sender does not know whether the attachment will be received by a desk computer equipped with MS-Office software, or a small device in the field with text-only capabilities. Transmission time could be one second, or 1000 seconds. The conventional work-around has been to send only the message headers to the Push device, and then let the user determine which messages to download. Clearly, this increases latency and user involvement.

Many Push devices can also act as Pull devices. As noted above, typical problems include: (1) limited memory and slow transmission speeds focus these devices on simple answers to simple questions; (2) the answers that are received are held in memory without any attempt at security; (3) if used for e-mail, there is no common ‘sent mail’ record; and (4) RF reliability and availability.

The third category in communication initiation is called “Dock.” Under this ad-hoc sync scheme, the user connects to their enterprise by visiting a “hot-spot” such as Starbucks, hotel, airport lounge, or other access point location. (This is similar to using a payphone.) Just as if they had gone to their office and docked their computer, the user now has the ability to connect at relatively high speed (<1500 kbps) and synchronize files or access information. Services offering this ability include BOINGO, Cometa Networks, and T-Mobile. Both Sprint PCS and AT&T Wireless offer this capability over WWAN, at a much slower speed (less than dial-up).

Typical disadvantages with this approach include: (1) the user must stay in the location until done; (2) if using web-based file storage, one must know in advance what one wants to download and arrange for it to be available; (3) there is no single store of information, i.e., different files and versions of files will exist on a user's PocketPC, home computer, office computer, and laptop; and (4) many files are shared with others, so that a file change may cause irreconcilable versions when one finally “Docks.”

The speed of current data communications (to an individual device) through wireless communications networks vary widely. Wireless Local Area Networks (WLANs), as mentioned above, provide fairly high-speed communications with brief latencies (although speed is usually limited by the supporting infrastructure to less than 1500 kilobits per second—and further limited if there is more than one active user). Users generally connect to WLANs while inside, or within approximately 100 feet of, a building equipped with a WLAN. However, WLANs are not suitable for users who spend much of their time in vehicles, traveling from one point to another, because WLANs are short-distance devices (by FCC power restrictions) and are typically used as a data communications infrastructure inside of buildings.

Wireless data-only and cellular networks, collectively referred to as Wireless Wide Area Networks (WWANs), use the wireless telephone infrastructure, or a dedicated infrastructure, to connect with users and transmit their data. Data transmission speeds are significantly slower than WLANs; however, these are the only technologies that are able to maintain contact with users in typical travels around the state. Wireless data-only networks are similar to cellular, but current deployments have been limited to metropolitan areas. Speeds of up to 70 kbps are now available, although less than 40 kbps (dial-up speed) is more commonly achieved.

C. System Response Latency with Current Technology

WLANs generally do not have latency problems. In general, their response times are less than 2 seconds.

The new Wireless (Telephone) Wide Area Networks (WWANs), using standards such as CDMA-1XRT and GSM/GPRS, provide users with much slower connection speeds (approximating dial-up performance) than are found in either hardwired or wireless local area networks. Thus, latency from queuing and slow transmission speeds will often be a significant problem when using these networks. For example, RIM Corporation's description of its Blackberry 2-way e-mail system states that a request to a user's mail server and the response from that mail server takes up to 30 seconds to complete through a WWAN (≅10 kbps). In comparison, it generally takes less than ½ second to achieve the same response on an office LAN (>10,000 kbps).

d. Dead Areas with Current Technology

Wireless telephone communications have numerous areas where a wireless connection cannot be obtained. In the current communications model, when a wireless connection path is not available to the wireless infrastructure equipment, any of the services the enterprise could provide are unavailable until the user can leave the dead area and logically reconnect. The user must actively seek a location with a sufficient signal; finding the location where a connection can be obtained is a manual process. When a user finally locates an area to connect with the wireless carrier, the user can connect with the network to send and receive data. The user must stay in the coverage area until the data interchange is complete. See FIG. 3 (Survivability of Various Communications Methods).

Dead-spots are sometimes caused by weak signal strength resulting from normal propagation losses. Increasing the power of the transmitters is not a good solution in most radio systems because it increases the level of interference encountered by all other users, and degrades battery life. With television, the viewer ignores the “snow.” In voice communication systems, the users relocate themselves to a better location, or delay the communication. In portable data communications systems, the only practical solution is to retransmit the data later on.

Dead-spots are sometimes caused by multipath, the out of phase reflections of the desired signal. A system of diversity antennas is commonly used in fixed systems, but is impractical with personal equipment because the small size leaves no room for a second antenna, and if such an antenna were added, it may not have sufficient separation from the primary antenna to provide reliable diversity operation. In addition, a larger battery would be required to support diversity processing. With television, the viewer reorients the antenna to minimize the “ghosts.” In voice communication systems, the users can hear the problem occurring and relocate themselves to a better location, or delay the communication. In portable data communications systems, the only practical solution is to retransmit the data later on, hoping the user (or the source of reflections) will have moved by then to a more favorably location.

Dead-spots are sometimes caused by interference from adjacent users or adjacent cells. When an FM radio broadcast is interfered with, listeners tune to a different station. In voice communication systems, the users relocate themselves to a better location, or delay the communication—waiting for the interference to cease. In data communications systems, the only practical solutions are either to retransmit the data a little later on, or to switch to a different communications channel, if available.

All these three above-mentioned conditions lead to typical measured (and designed-to) reliability of portable communications systems of approximately 90%, i.e., 90% of the locations, 90% of the time. Public safety systems are typically designed to 95% of the locations, 95% of the time, by using diversity schemes and by increasing transmitter power—disregarding interference to adjacent systems (through a process of neighborly coordination).

e. Wireless Availability and Compatibility with Current Technology

North America has many wireless carriers, and multiple communications standards with numerous opportunities for incompatibilities. Furthermore, all carriers do not cover all geographic areas, nor have roaming agreements in these areas. The design reliability of RF propagation is generally 90%. It is difficult for the average user to contend with these issues.

f. Current Communications Model

The current wireless communications model, as shown in FIG. 4 (Standard Real-Time Connection Model Through Wireless Connection), is based on essentially the same model as used in offices that have high-speed wired communications systems, where connections with the enterprise are handled in real time, and the server response latencies are generally short. Office LANs can provide high bandwidth and short server access-time latencies at low cost. Connections with the enterprise system are handled on an “On-demand” basis.

The current, “On-demand” wireless communications model requires that users be connected to the wireless communications network in order to receive or send data. Users receive bandwidth from the network on an “On-demand” basis as shown in FIG. 4.

The connection between the user's device and the Enterprise System is manually initiated, that is, initiated by the user. This model, when used in the office, presents no connection barriers to the user—the connection is always available. But the communications through wireless is of a different nature than LAN communications in the office. Thus, if a user wants to send an e-mail message through the wireless communications system, the user must have an active connection at the time the message is sent. Therefore, the user must:
Find a location where either a WWAN or WLAN connection can be obtained, and maintained.
Establish the connection.
Once connected to the wireless network, endure the latencies of the wireless network.

The interaction between the user and the enterprise over the wireless network must be initiated by the user and take place in real time. The “On-demand” connection model over wireless connections can prove intolerable given the connection problems and the long latencies encountered sending and receiving large files over the wireless networks.

g. Security Issues

A tactic to overcome some of the problems of wireless connectivity is to enable access through multiple wireless networks. However, each wireless protocol has its own security system. In addition, that security may or may not be engaged. To overcome the multiple network security problems, an application-level security system may be required that does not rely on the wireless security system to be engaged in order to ensure secure data transfer.
Industry experts believe that to be successful, any system must be known as a system that is always completely secure. The two greatest vulnerabilities are (1) the over-the-air links, because insiders have access to much clear-text and corresponding over-the-air cipher-text; (2) the clear-text (decrypted) files stored in the field on PCs.

h. Channel-Loading

Both average data loading and average voice loading experience predictable highs and lows during a 7-day week. When one examines loading of voice (for example) at a single cell site, however, the peaks and valleys over the course of a few moments are more severe than the average, leading to “system busy” conditions when the site is overloaded. The practice of the wireless communications industry is to provide an “acceptable” level of failed attempts, as is done in the wired telephone industry. The net effect of this is to delay the traffic until later, when channels open up. In voice systems this works quite well as users sporadically try later, or abandon the call altogether. In data systems, the equipment is programmed to retry again, colliding with other similar units, actually limiting throughput below optimum. Eventually all the traffic is handled (or abandoned), but with unhappy users and much delay. This resulting latency is often greater than the patience of the user.

Any delay leads to user dissatisfaction, which increases churn (switching carriers). The carrier's alternative to handle the traffic is to build additional infrastructure, investment that is needed perhaps only 1% of a typical week.

Since information is more valuable when delivered in a timely manner, trying to provide the bandwidth to users in real time leads to building expensive reserve infrastructure just to provide connections during peak periods. The higher the peaks relative to overall average usage, the greater the expense to the carrier to provide the reserve infrastructure. Reserve infrastructure does not produce revenue most of the time; thus any way the carrier can reduce the reserve while still providing an acceptable level of service will lower infrastructure costs to the carrier. Shifting as much usage from an “On-demand” to an “As-available” basis reduces peak demand and thus reduces the need for reserve infrastructure.

i. High Cost of “On-Demand” Airtime

A typical digital voice call transmits 8 kbps (8000 bits per second) of airtime. The cellular (or data system) carrier typically receives $0.11 for a minute of voice airtime during the workday, passing 60 kilobytes (480 kilobits) in a minute. A data file could be downloaded at that speed (or many times that speed, depending on the system). With error correction and redundant coding, this allows downloading a file of perhaps 30 kilobytes—equivalent to an average-sized e-mail—also for $0.11. A three megabyte file attachment would cost approximately $11.

These costs will quickly add up as users download/upload presentations and other large attachments, or view web pages. The carrier would prefer to remain revenue-neutral between data and voice, and is not inclined to reduce the charge for data. However, the carrier would be willing to provide reduced charges for delivering ‘deferrable’ data packets (using “As-available” airtime) as possible with this invention, since it would allow the carrier to more efficiently utilize its existing infrastructure, just as they offer discount pricing for nights and weekends. Users, however, are not interested in waiting for their information.

“On-demand” connections force infrastructure builders to build a network to handle peak usage. This significantly increases costs to both the user and the provider. As discussed above, bandwidth usage on an “As-available” basis reduces infrastructure requirements and thus a provider could sell bandwidth to “As-available” users at a much lower cost than to “On-demand” users.

(Building infrastructure to handle peak usage levels means that wireless access points are unused much of the time. Building an infrastructure to handle average usage would mean that a provider could build a less costly and lower priced infrastructure.)

j. Problematic Inquiry/Response Technique:

To receive information from a database, the mobile worker with today's systems must first structure up an inquiry. This is accomplished by inputting what is desired with a stylus, keypad or thumb-pad. The inquiry is then transmitted in to the enterprise. With the 2.5 G systems available in 2003, the speed of transmission is approximately equal to dial-up speed. After a short delay, and assuming off-peak time of day, the response is returned to the user's device, at dial-up speed.

At this point the mobile worker has spent considerable time and received little information. This is especially true if the request was to confirm availability, and the response was: “None.” The mobile worker must now determine what might be a substitute, and then again structure up an inquiry to request availability.

The length of the response can also be an issue if, for example, the information being returned is a medical record and the paramedic has to wait for the transmission to finish before administering a critical medication. Similarly, if repair information is being downloaded, the duration of the transmission may seem excessive to the customer who is paying the repair person by the hour.

Since information is transmitted too slowly, and because it is difficult and time consuming to structure an inquiry, a possibly better alternative that can be used is to deliver as much information as possible “in advance.”

k. Low Throughput on WWANs

Current “2.5 G” generation WWANs provide connections approximating dial-up speed. Future “3 G” third generation promise speeds greater than 384 kbps, approximating a home DSL connection (somewhat slower than a home cable modem). However, a connection that fast would require that the wireless carrier allocate almost all the available bandwidth to one user. In reality, maximum connection speeds will likely be no more than 140 kbps and most frequently near 70 kbps, and this estimate does not factor in overall throughput reductions that would be created by poor and dropped connections.

l. Conclusion

As a result of the many limitations described below, communicating through existing wireless systems in real-time can be daunting for many users.

### SUMMARY

In a first principal aspect, the present invention provides a sync-seeking system comprising a central server and a portable server. The central server stores a central-server copy of original data and can accumulate central-server changes to the central-server copy. The portable server stores a portable-server copy of the original data and can accumulate portable-server changes to the portable-server copy. The central server and portable server engage in peer-to-peer communication, via at least one wireless network, to exchange any central-server changes that have been accumulated by the central server and any portable-server changes that have been accumulated by the portable server until the central server and the portable server each store a copy of synchronized data.

In a second principal aspect, the present invention provides a sync-seeking system comprising a central server, a first portable server, and a second portable server. The central server stores a central-server copy of shared data and can accumulate central-server changes to said central-server copy. The first portable server stores a first-portable-server copy of the shared data and can accumulate first-portable-server changes to the first-portable-server copy. The second portable server stores a second-portable-server copy of the shared data and can accumulate second-portable-server changes to the second-portable-server copy. The central server and the first portable server engage in peer-to-peer communication, via at least one wireless network, to exchange any central-server changes that have been accumulated by the central server and any first-portable-server changes that have been accumulated by the first portable server, and the central server and the second portable server engage in peer-to-peer communication, via at least one wireless network, to exchange any central-server changes that have been accumulated by the central server and any second-portable-server changes that have been accumulated by the second portable server, until the central server, first portable server, and second portable server each store a copy of synchronized data.

In a third principle aspect, the present invention provides a method for synchronizing a central server and a portable server. In accordance with the method, the central server collects central-server information for delivery to the portable server, and the portable server collects portable-server information for delivery to the central server. The portable server establishes a wireless connection with at least one wireless network. The central server and the portable server establish a logical connection via the at least one wireless network. The central server and the portable server engage in peer-to-peer communication, via the logical connection, wherein the central server transfers the central-server information to the portable server and the portable server transfers the portable-server information to the central server.

In a fourth principle aspect, the present invention provides a sync-seeking system comprising a portable server, a first central server, and a second central server. The portable server stores a first-portable-server copy of first original data and a second-portable-server copy of second original data and can accumulate first-portable-server changes to the first-portable-server copy and second-portable-server changes to the second-portable-server copy. The first central server stores a first-central-server copy of the first original data and can accumulate first-central-server changes to the first-central-server copy. The second central server stores a second-central-server copy of the second original data and can accumulate second-central-server changes to the second-central-server copy. The first central server and the portable server engage in peer-to-peer communication, via at least one wireless network, to exchange any first-central-server changes that have been accumulated by the first central server and any first-portable-server changes that have been accumulated by the portable server until the first central server and the portable server each store a copy of first synchronized data that corresponds to the first original data as modified by the any first-central-server changes and the any first-portable-server changes. The second central server and the portable server engage in peer-to-peer communication, via at least one wireless network, to exchange any second-central-server changes that have been accumulated by the second central server and any second-portable-server changes that have been accumulated by the portable server until the second central server and the portable server each store a copy of second synchronized data that corresponds to the second original data as modified by the any second-central-server changes and the any second-portable-server changes.

### BRIEF DESCRIPTION OF THE DRAWINGS

FIG. 1 is a simplified block diagram showing the interrelationship of a central server 10 and a portable server 12 in a sync-seeking system, in accordance with an exemplary embodiment of the present invention. Central server 10 and portable server 12 may engage in two-way communication via a wireless wide area network (WWAN) 14 and/or a wireless local area network (WLAN) 16. WWAN 14 could be a cellular or digital packet data network (e.g., GPRS/CDMA). WLAN 16 could be, for example, an 802.11 or Wi-Fi network. Central server 10 may be connected to WWAN 14 and WWAN 16 via a network 18 (not shown in FIG. 1). Central server 10 may also be connected, via a network 20, to other networks and/or systems, such as an enterprise system 22, a home PC 24, Internet 26, other networks/systems 28, or even other central servers 30. Networks 18 and 20 could include public networks, such as the Internet and/or private networks, such as a local area network (LAN). Portable server 12 may have one or more wireless links (e.g., via a local WLAN) to one or more display devices 32. Display devices 32 may include as a laptop computer 34, a personal digital assistant (PDA) 36, a set-top box 38, and/or a wireless (e.g., WLAN or cellular) phone 40.

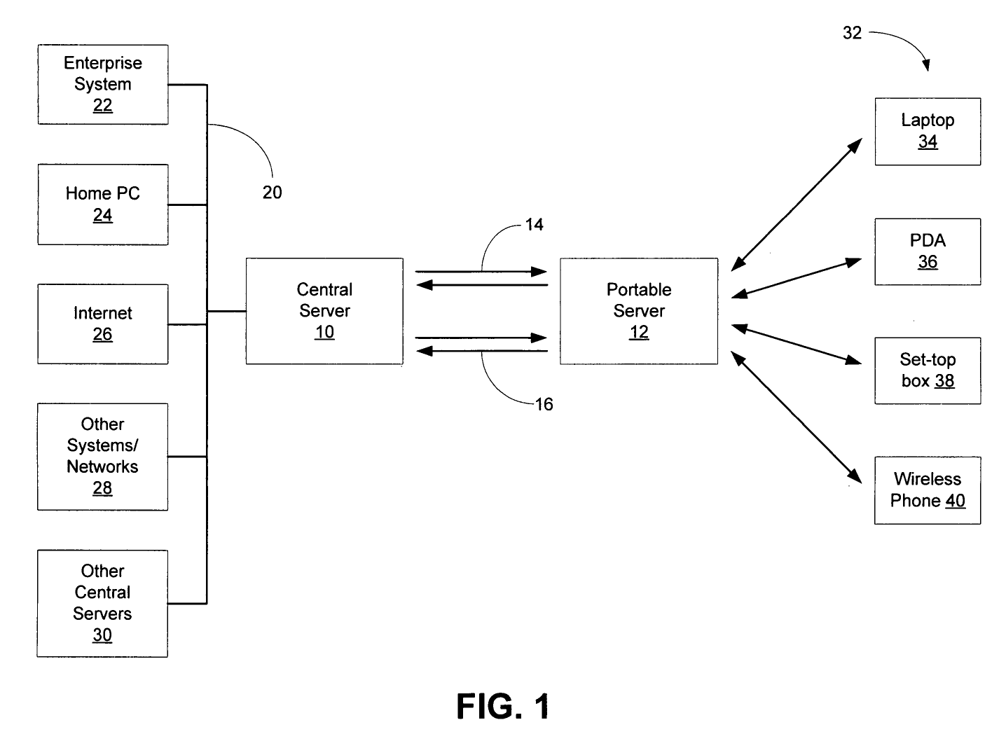

FIG. 2 is a diagram showing a security model, in accordance with an exemplary embodiment of the present invention.

FIG. 3 is a chart showing the survivability of various communications methods.

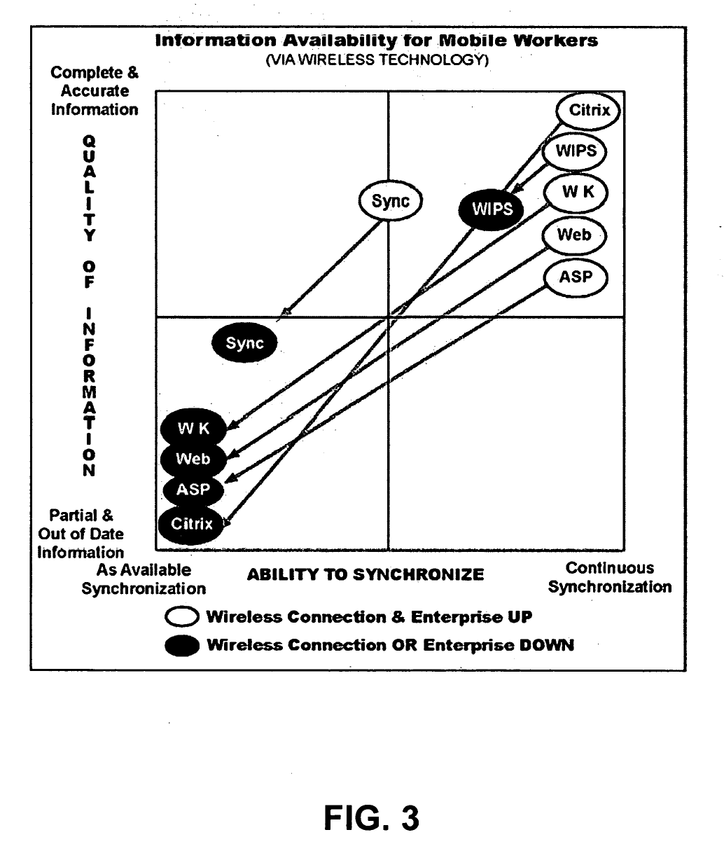

FIG. 4 is a simplified block diagram showing the current wireless communications model, namely, real-time connection through a wireless connection.

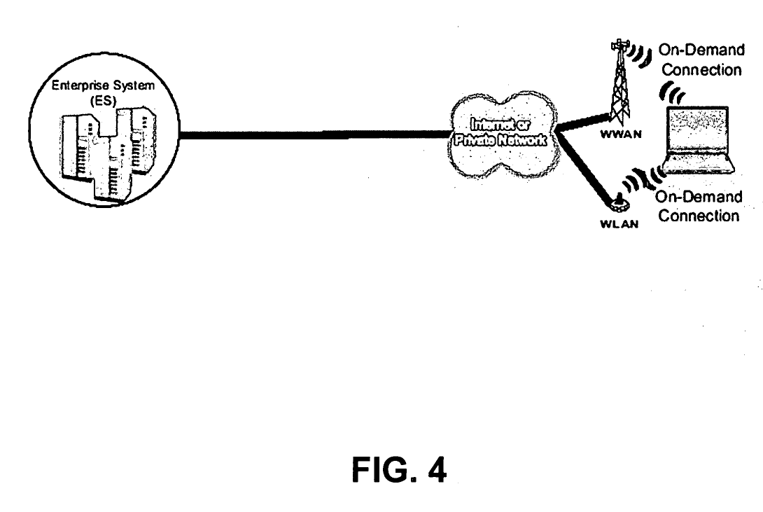

FIG. 5 is simplified block diagram showing a communications model, in accordance with an exemplary embodiment of the present invention. In this communications model, central server 10 communicates with enterprise network 22, via network 20. Central server 10 also communicates with portable server 12, via network 18 and WWAN 14 and/or WLAN 16, using “as-available” wireless connections. Portable server 12 communicates with one or more one or more display devices 32, for example, using an “on-demand” wireless connection.

FIG. 6 is simplified block diagram illustrating security features, in accordance with an exemplary embodiment of the present invention.

FIG. 7 is a simplified block diagram illustrating a 2-way connection bridge between central server 10 and portable server 12, in accordance with an exemplary embodiment of the present invention.

FIG. 8 is a central server state diagram, in accordance with an exemplary embodiment of the present invention.

FIG. 9 is a portable server state diagram, in accordance with an exemplary embodiment of the present invention.

FIG. 10 shows a server couplet between a central server and two portable servers, in accordance with an exemplary embodiment of the present invention.

FIG. 11 is a simplified block diagram showing the relationship between processes in central server 10 and processes in portable server 12, in accordance with an exemplary embodiment of the present invention.

FIG. 12 is a simplified block diagram showing portable servers that are linked to more than one central server, in accordance with an exemplary embodiment of the present invention.

FIG. 13 is a simplified block diagram showing processes in central server 10 and in portable server 12 when portable server 10 is linked to multiple central servers, in accordance with an exemplary embodiment of the present invention.

FIG. 14 is simplified block diagram showing processes in central server 10 and in portable server 10 when portable server 10 is integrated into a display device, in accordance with an exemplary embodiment of the present invention.

FIG. 15 is a software system diagram for a portable server integrated into a display device, in accordance with an exemplary embodiment of the present invention.

FIG. 16 is a simplified block diagram showing processes in central server 10 and in portable server 10 when portable server 10 uses an external wireless phone 42 as a wireless modem for communicating with WWAN 14, in accordance with an exemplary embodiment of the present invention.

FIG. 17 is a simplified block diagram showing how a user's information that is located on multiple legacy systems can be consolidated, in accordance with an exemplary embodiment of the present invention.

FIG. 18 a simplified block diagram showing processes in central server 10 and in portable server 10 when portable server 10 is integrated into a display device and uses an external wireless phone 42 as a wireless modem for communicating with WWAN 14, in accordance with an exemplary embodiment of the present invention.

### DETAILED DESCRIPTION OF EXEMPLARY EMBODIMENTS

1. Overview

a. Purpose

One purpose of this invention is to increase both the productivity of mobile workers (while saving money) and the economic and technical viability of wireless data communications. This technology can provide users with office-like data communications capability, as if using a wired system, but using instead the wireless communications infrastructure.

Potential benefits include: (1) reducing the delay between a user's request for information and the fulfillment of that need; (2) reducing the transaction load on the individual for predefined information and/or predictable transactions, (3) delivering copies of web seminars, analyst meetings, subscription content, and similar fare, written or audio/visual graphic and other media, for use at a later time by the owner, if desired; and (4) providing Internet, intranet and database ‘replication’ from and onto the Portable-Server, consolidating a person's resources in their pocket.

Exemplary considerations can include:
Data consistency
Wireless network throughput
Data latency
Airtime costs
User acceptance
Ability to assure that the mobile worker can only access the latest information
RF reliability
RF availability
Survivability (continued operation) for those times when the enterprise is ‘down’ or otherwise not available
Security of information in the field from external and internal threats
Security of information in transit (i.e., over the air)
Sufficient storage for the all of the user's information needs
Diversity of wireless transmission
Techniques for automatically selecting wireless networks and type of connection,
Techniques for automatically recovering from errors including transmission interrupts, noisy connections and data integrity violations
Techniques for automatically determining possible connections
Various embodiments
Security from hackers
Battery life extension
Guaranteed delivery of information

b. Mobile Wireless Data Market Dynamics

Cost saving and productivity increases garnered by not tethering a mobile worker to his or her desk are driving the market for wireless information. As evidenced with PCs and cell-phones, companies embrace technologies that allow leaps in productivity.

Business users were the earliest drivers of wireless voice communication and will become the earliest drivers of the wireless data services, as it becomes increasingly more valuable to be able to send and receive e-mail, check inventory, and access corporate information from remote locations. Many business people who use wireless phones today and do not currently have wireless data access, are likely to add this feature in the near future, making wireless information access a high growth arena in the wireless industry.

Wireless data can help businesses, giving sales professionals the ability to access catalog listings, customer history, product specifications, inventory levels, shipping data and other key information—while en route to a client's office. Traveling executives and managers want instant access to critical corporate information from company databases. The greatest appetite for these services will probably come from workers in the field.

Businesses increasingly communicate via electronic means—E-mail has become a way of life for many mobile workers; they use it day in and day out to communicate with customers, suppliers, colleagues, and superiors. While e-mail represents a major wireless data opportunity, having e-mail access everywhere does not solve wireless corporate data requirements. As e-mail becomes increasingly prevalent, so do attachments. E-mail becomes the “Post-it” note attached to the face of a document (attachment) that needs immediate attention. Just as wireless phones revolutionized the verbal communication needs of businesses and individuals, wireless data access will revolutionize the concept of the mobile office. True productivity gains will be realized when workers only need to return to an office for social reasons—not to get a file or send a message.

WWAN wireless carriers such as AT&T Wireless, Nextel, Cingular, Sprint PCS, T-Mobile (formerly called Voice Stream), and Verizon already have much of the capabilities currently in place to provide wireless data service to support this invention. These companies all have operating wireless telephone networks that are underutilized except during peak times. This invention, called WIPSS (Wireless Intelligent Portable Server System), offers these companies the ability to level their traffic loading because WIPSS data traffic can be given a lower priority than voice; i.e., at peak times data transmissions can be delayed slightly until channel loading permits. Also, data can also be sent over channels normally reserved for roamers; this data traffic could be suspended if a channel is needed for a roamer, then resumed when the voice traffic is over. Actually, WIPSS tolerance for “ruthless preemption” could allow more channel reserve for roamers (helping to eliminate dropped calls) while increasing total traffic (WIPSS and voice), with little or no additional investment in infrastructure to support peak usage.

Wireless carriers also have the capability to provide Wireless-LAN networks or negotiate cost-effective roaming agreements with others. Several carriers have announced their intention to create nationwide WLAN networks; possibly these will evolve similarly to cellular networks and roaming agreements will be created. The dual functionality of WIPSS (WLAN and WWAN connectivity) allows the carriers to provide functionality and establishing a base of billing for their fledging WLAN networks.

WIPSS technology addresses numerous opportunities in its implementation and usage. The end-user market could consist of millions of ‘mobile workers’ worldwide across four primary classifications:
Field Service Engineers, who as ‘field production workers’ are most effective when at the job site.
Sales Personnel, who need large amounts of customer history, order and inventory information at any time, and should not have to drive back to the office to get that information.
Mobile Executives, who need immediate access to all types of strategic and operational business information, regardless of location and proximity to telecom facilities.
Public Service, consisting of roles such as the military/government sector, health care providers, Homeland Security, etc.; in short, all the other workers who regularly do their work outside of a brick-and-mortar office setting, and need immediate information to patient histories, building permits, etc.

In addition, there is a large potential market for consumer use. Our new wireless data communications technology addresses the problems limiting the acceptance of wireless data among mobile workers, as shown in Table 1, and is designed to provide to mobile workers, at an affordable price, nearly identical information capabilities to that office workers now enjoy.

TABLE 1
Current Issues and Solutions with WIPSS

| ISSUES: | SOLUTIONS: |
|---|---|
| Airtime cost | “As-available” airtime |
| Security of data in the | Data remains encrypted |
| field | |
| Administration of | Enterprise retains control, and can erase |
| security | |
| Battery drain | Laptop power conserved |
| RF Reliability | Increased by space, time, & frequency diversity |
| RF Availability | Opportunistic connections, WWAN & WLAN |
| Speed (1000 sec to open | Pre-positioning = Instant access (<1 sec.) |
| 5 MB file) | |
| No Authorization/ | Central-Server + Portable-Server pair provides |
| Authentication | Authorization and Authentication |
| Difficult user interface | User interface is “Just like at the office” |
| System goes ‘down’ | Portable-Server is always ‘up’ |
| Latency/Queuing | Outside of user's perspective |

2. Wireless Intelligent Portable-Server System (WIPSS) Technology

This technology is specifically targeted to mobile workers, and to those who normally work out of an office environment but have an occasional need for quick access to large amounts of information. This technology can enable high volume, two-way data access through wireless data communications channels. Furthermore, users of this technology may experience access latencies not much greater than experienced through a local area network.

Current approaches have users interact with enterprise servers while connected to the wireless network. Users experience the latencies and all other problems of the wireless network while attempting to perform their tasks.

To address latency problems, we provide a new model of distributed computing, and the methods to support this new model.

The innovative approach in this document describes methods that can enable the user to send and receive data without with the latencies of the WWAN or WLAN networks. A new device is proposed, called a Portable-Server (PS), and another device called a Central-Server (CS). The CS and PS work through the problems of wireless connections in the background so as to spare the user the delays, difficulties and problems of the wireless connection. The CS and PS exchange data through the wireless network on an “As-available” basis and in a timely manner. The user can then access the data from the PS in the same, nearly instantaneous manner as would be available from a server over a wired, local area network (LAN) connection.

This invention also provides a new protocol, called “POST,” for communications initiation by often-disconnected devices. POST is an acronym for Paired Opportunistic Swap Technology. POST uses Sync-Seeking servers with an intelligent agent to support an individual mobile user, so that each server is in the best possible position to serve the mobile user when communications are established. In the POST approach, each server in the pair collects information in a queue for exchange with the other server in the pair when a wireless connection becomes available. Data—e-mail, documents, programs, file and database updates, etc.—are “POSTed” to the user's PS through the wireless network on an on-going basis. The user interacts with the data once received in its entirety. (The PS has large storage capability, similar to an office computer.) Furthermore, sending data back through the wireless network, the user is not required to directly interact with the WWAN or WLAN, and yet the data travels automatically to its destination through the wireless network.

To explain various aspects of this invention, we define exemplary domains and describe exemplary methods. The domains described will be: The logical equivalence between the PS and CS, the innovative aspects of this conceptual change in computing and communications, and the business problem that using this new concept will solve. In its exemplary embodiments, the invention may make use of the following methods:
1. Methods for connecting the two servers across one or more wireless networks.
   Including methods for selecting between more than one wireless network
   Including the methods for transmitting and receiving data
   Including methods for automatically detecting a wireless carrier and establishing a two-way connection
2. Methods for a display device to connect with and view data and electronic mail stored on the PS.
3. Methods for replicating data and reflecting changes between the CS and PSs.
   Including methods to determine, transmit and incorporate the incremental changes
   Including methods to manage the changes
4. Methods for data storage and transmission security, including authentication and encryption.

a. Logical Equivalence

This system consists of a PS connected to one or a plurality of wireless communications networks. The system also consists of software that operates on a typically stationary CS. A critical feature of this technology is that the PS is a logical extension of the CS (and vice versa).

At rest, the PS has data that is essentially a duplicate image of data on a designated logical portion of the CS. Any update to the affected data in the CS will be reflected to the Portable-Server. Furthermore, any update to data on the PS will be replicated back to the Central-Server. The Central-Servers and Portable-Servers will be continuously attempting to be equivalent.

Physically, the CS may be a stand-alone device, or part of the enterprise system. Logically, the CS may include management software to:
Maintain two-way communication with one or more of the PSs,
Communicate with those PSs it is responsible for and can validate,
Interface and communicate with other data systems.

In its most preferred embodiments, the invention is:
Wireless carrier and wireless channel independent, and can use current and future commercial communications technology;
Data transport network and data transport protocol independent, so that data can travel through any data communications network (public or private) when available.

b. Distributing a Central-Server onto Portable-Servers

The solution described herein introduces the concept of providing the user with a PS computer that functions as a logical equivalent of a subset of the CS computer. Moreover, the WIPSS communications model is designed to handle unreliable wireless communications. In particular, disparities between the servers that may develop when they are unconnected may be corrected when they are re-connected.

c. Connecting Sync-Seeking Servers over Wireless Connections

This invention provides a solution to problems with wireless connections and provides logical methods for utilizing the benefits of wireless technology. In particular, the invention adapts to discontinuous wireless connections between the servers.

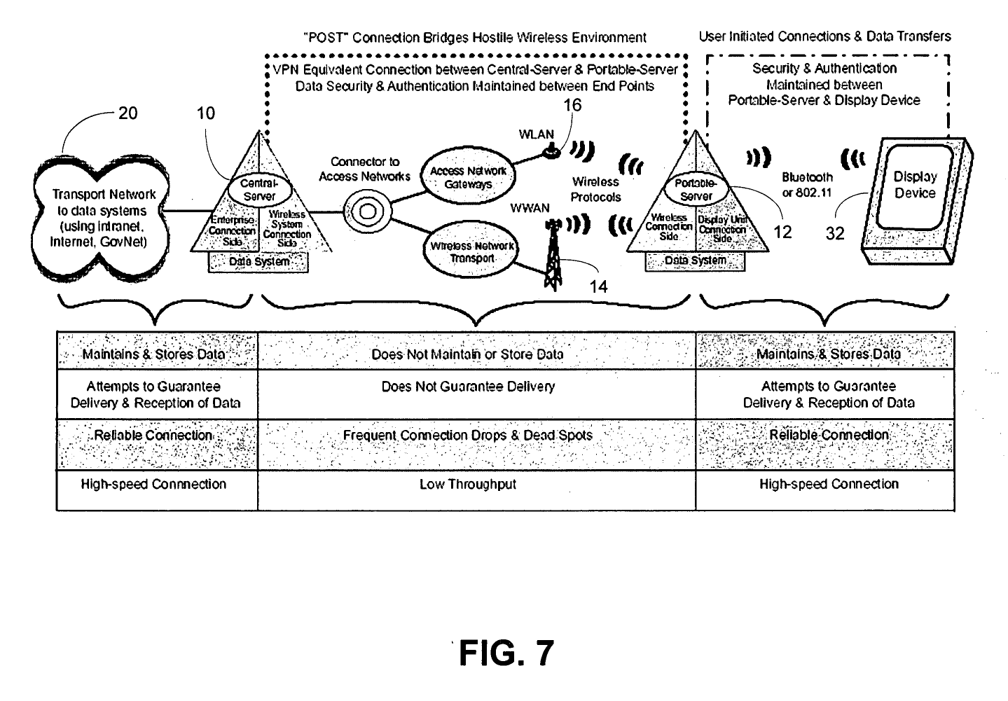

FIG. 7 (WEPSS 2-Way Connection Bridge) shows the fundamental parts of the connection model between the Sync-Seeking servers. Between the Sync-Seeking servers are wireless connections that (in many cases):
Do not maintain or store data.
Do not guarantee delivery between two points. In other words, when data is transmitted, the transmitter does not verify that the receiver received the data and whether that data was received error-free.
Frequently drop connections. Typically, wireless networks do not actively attempt to reacquire the dropped connections.
Are unreliable. Wireless data networks are found within metropolitan areas and in many cases, the coverage is spotty in the outer reaches of these areas. Furthermore, even within these areas, there will be dead spots and areas of such poor signal quality that these areas are functionally dead.
Are slow. Other than short-range WLANs, wireless data networks have low throughput even when conditions are optimal. A large file transmitted over a WWAN network could easily require 30 to 45 minutes or more to complete. A person working in the field could not perform the required tasks if the person were required to manually connect with a WWAN network and then monitor each transmission of a large file.

Some solution providers have dispensed with having the user connect with a WWAN to synchronize their files with the server. In these connection models, the user must connect to the enterprise locally through an office LAN connection. Special software then synchronizes the enterprise with the computer used in the field. However, in this model the user must make a special trip to a fixed location in order to connect with the enterprise.

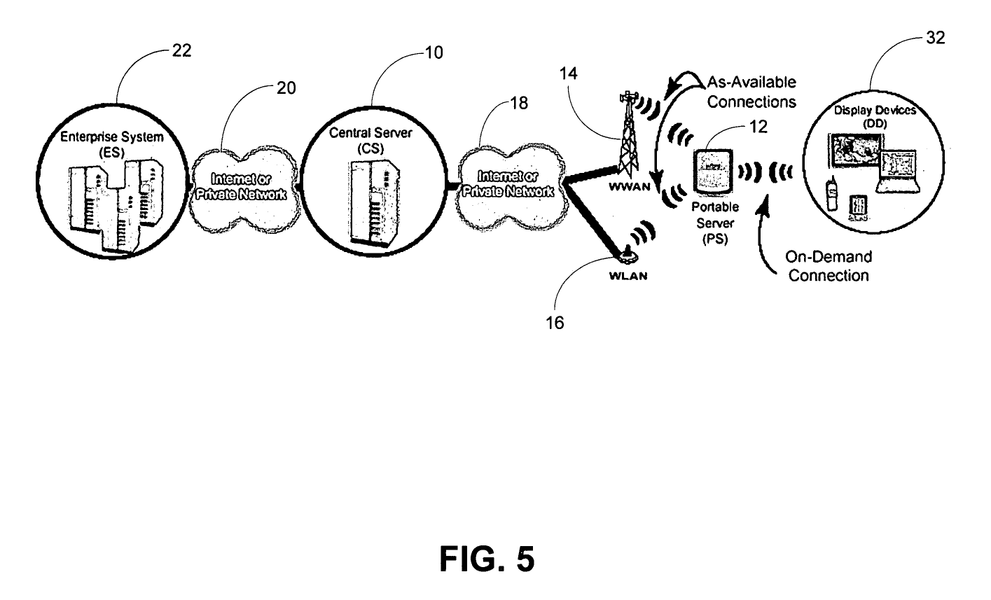

As shown in FIG. 5 (Connection Model Through WIPSS):
The PS creates two-way Virtual Circuits with CS.
Data packets and acknowledgements can travel through the same (or different) communications channels, i.e., if a Virtual Circuit has been established on a wireless telephone data communications channel, then data packets sent from the CS and the packet reception acknowledgements usually travel on the same two-way connection.

The WIPSS connection model can utilize most available wireless data networks. In the WIPSS connection model, the user carries a PS that is logically equivalent to a segment of the CS and thus:
user is no longer required to be connected in real time to the wireless network,
user can experience a simulated “On-demand” connection with an “As-available” wireless network via their Portable-Server,
user is not required to make a special trip to the office to connect to the enterprise through a LAN in order to synchronize files.

The CS typically has an Internet IP address that is permanent. The PS typically has a constantly changing address (e.g., a DHCP network address) based on the technology in use at the carrier. Each time the connection between the PS and the carrier's network drops, the PS will likely be reassigned to a new network address. In addition, the PS could be assigned two temporary network addresses simultaneously; one address could be a WWAN address and the other a WLAN address. The PS could also signal to the CS the address that is “Active” and the one that is “Standby.” More detail regarding these connection methods will be discussed in a later section.

The WIPSS connection model involves use of a private, inter-server messaging system that uses peer-to-peer communications with a private messaging protocol within a standard data communications protocol. Thus we are able to use public data communications network such as the Internet (that uses TCP/IP and UDP), but send encrypted private messages between the Sync-Seeking servers. Furthermore, WIPSS communications model can be connection independent, so that it does not matter if a connection is made through a WWAN or WLAN connection—in series or in parallel. The communications model is designed to enable the following types of data flow no matter the path:
Authentication between the Sync-Seeking servers;
Resynchronization between the Sync-Seeking servers and resetting data encryption, selecting new encryption keys (without ever transferring keys) and thus develop a secure, VPN-like communications;
Inter-server process restarts and continuations of both data and file transfers, and of e-mail messages;
Establishment of two-way Virtual Circuits(s);

Connection breaks involve secure reestablishment of communications (because of rolling codes used for asymmetrical encryption keys) with the most remote possibility of spoofing or breaking into the communications system.

TABLE 2
Connection Status

| Connection State | Action(s) |
|---|---|
| Disconnected | Search for wireless connection (based on wireless connection selection |
| | methods) |
| Wireless network detected | Establish low-level communications. The PS sends its new network |
| | address to the Central-Server. |
| Low-level communications | Establish network communications path - data routing. CS verifies that |
| established | the network address update was from one of the Portable-Servers on its |
| | list of PSs. Data for authentication and security can now be established. |
| Access and transport enabled | Authenticate: Each server authenticates the other. If authentication fails, |
| | connection is dropped; and an attempt is made to reestablish the |
| | communications path and authenticate. |
| Authentication established | Reset encryption. Select new encryption keys. Resynchronize key |
| | rotation. |
| Secure communications | Establish where differences between Sync-Seeking servers exist. Queue |
| established | up tasks. Determine if any pre-established process requires completion |
| | or continuation from where it left off. |
| Replication map developed | Necessary two-way virtual circuits established. |
| Start and restart processes | Two-way data transfer commences and/or continues. |

In the WIPSS connection model, establishment of a connection between the Sync-Seeking servers takes place in the manner shown in Table 2, from the fully disconnected state.

This invention is intended to be transport-network neutral and protocol neutral. Transport of data can be through the Internet or through a private network. The methods described do not require use of a particular access or transport protocol in order to function properly.

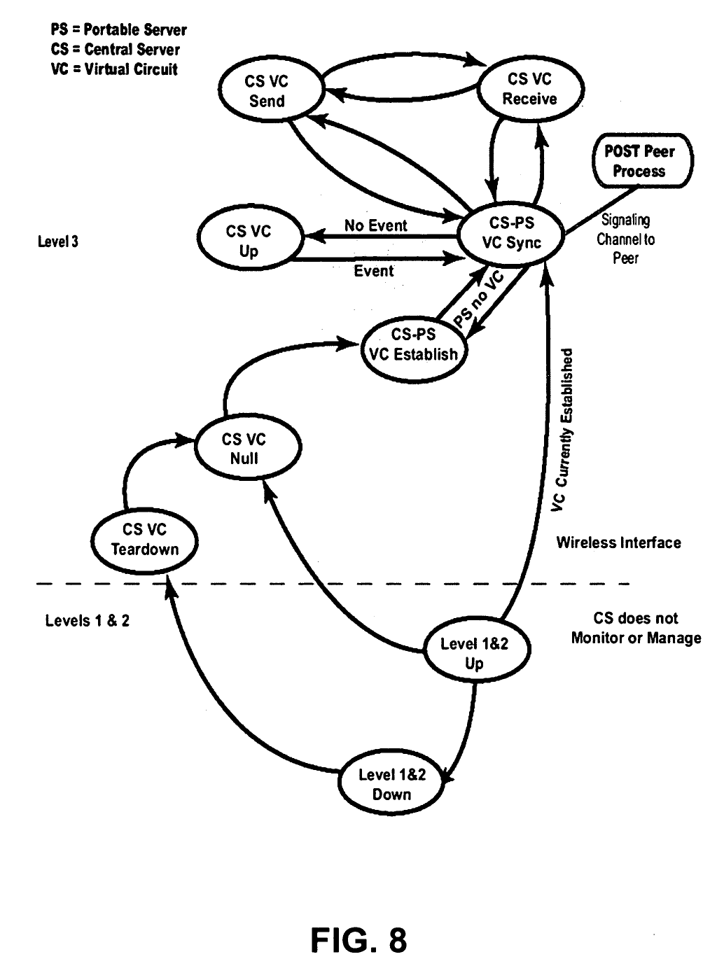

FIG. 8 (Central-Server State Diagram) shows the states and transitions of the Central-Server in an exemplary embodiment. The CS state diagrams shows that state and state transitions are independent of the type of wireless connection. The most significant state in this diagram is the Sync-Seeking State. Every change in communications activity begins with a transition to this state. It is also the point where a peer process, that is also resident in the PS unit, can affect communications activity.

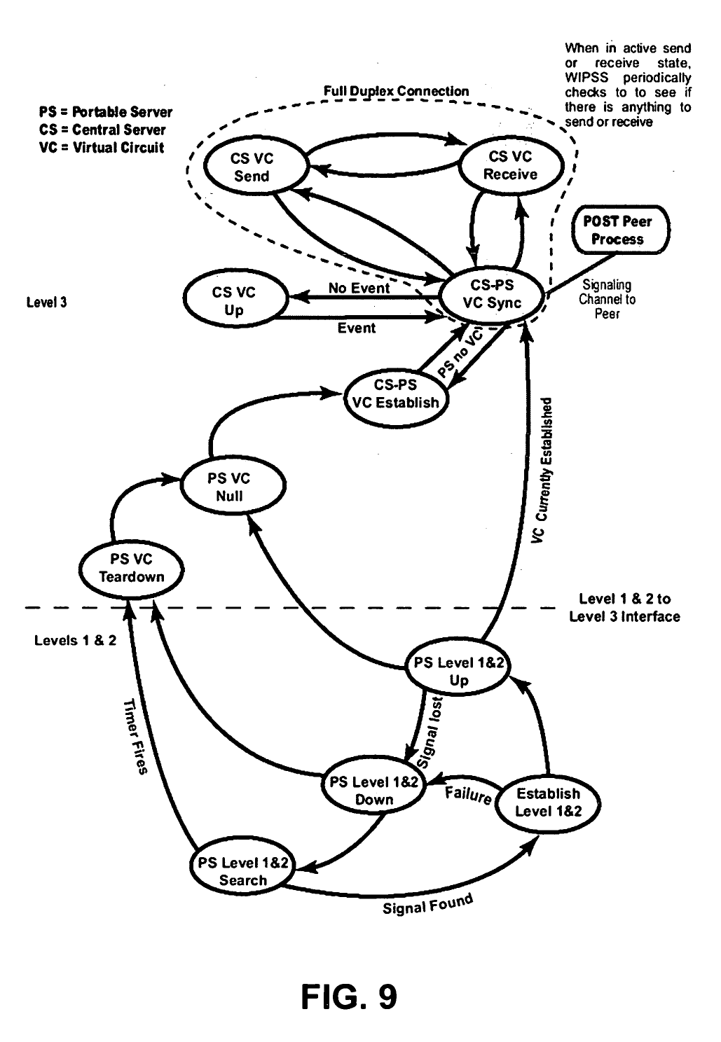

FIG. 9 (Portable-Server State Diagram) is the communications state diagram for the PS in an exemplary embodiment. The CS and the PS have companion state diagrams with peer processes that affect their operation at the Sync-Seeking State. The primary difference between the diagrams is that the PS manages the wireless connection and the CS does not, as shown by comparing the section of the diagrams below the dashed line—or the wireless interface line. The reason for this difference is that the PS knows how to find the Central-Server, since the IP address of the CS is typically constant, whereas the IP address of the PS typically is not constant.

In addition to that shown on the state diagrams, the CS is responsible for interfacing with and tracking changes in outside data repositories, while the PS handles Display Devices.

As will be discussed, the peer processes are also in communication and have responsibility for overall paired system “POSTing,” but at a higher level. This is discussed in a later section.

d. Wireless Access Selection Methods

This invention can use redundant wireless data communications methods. More than one wireless channel can be used to transfer data. Communication data between the CS and PS can flow through its WLAN channel, and/or a WWAN channel, or may use a future wireless telephone or satellite data network access standard (or even a wire-line connection). Preferably, the PS manages the wireless connection, initiating the connection with the wireless network and attempting to reconnect with it when a wireless connection has been dropped, selecting between possible networks based on things like price of the choices, speed of the choices, amount of information queued for transfer (in each direction), amount of a given file left to be transferred, predefined priority level (reference material such as an instruction manual update vs. transactional material such as changing inventory levels), if an e-mail has a “TO:” vs. a “CC:” designation, user preferences, need for Instant Messaging, need for on-line, On-demand (pipeline mode) access, etc. This can be further modified by cost considerations, especially when additional connection choices exist, an example of which is shown in Table 3. As illustrated by Table 3, weighted values could be used, depending on the user or system preferences, and availability, to continually decide the best choice or choices. Because queues develop when the peered servers are not connected, the Selection Score can change rapidly, and the advantage of using more than one channel in parallel may look more attractive. It is important that WIPSS, as provisioned by the user, consider not only the absolute cost, but also the time-value of delay, the transmission speed available, and the file and queue sizes.

TABLE 3
Connection Choice Algorithm

| ALGORITHM | Home cellular | Prepaid or | Subscription | Roaming |
|---|---|---|---|---|
| MATRIX | carrier | free WLAN | WLAN | Cellular |
| Any traffic queued? (Y/N) | 3/1 | 4/0 | 3/0 | 1/0 |
| Large traffic queue? (Y/N) | 1/0 | 4/0 | 4/0 | 1/0 |
| Price | 3 | 4 | 1 | 2 |
| Pipeline/surf request? (Y/N) | 2/0 | 4/1 | 3/0 | 1/0 |
| IM request (On-demand)? (Y/N) | 2/0 | 3/0 | 3/0 | 1/0 |
| Voice (Y/N) | 4/0 | 3/0 | 1/0 | 2/0 |
| SELECTION SCORE: | | | | |

The PS and CS have the ability to transmit files to one another based on link price, file size, file importance, and the time the user requires the file. Optionally, the user of the PS may set preferences that a certain file must be transferred at any cost within a certain amount of time. Or the user may determine that a file should be replicated within a certain amount of time or days for a minimal amount of money. The cost associated with passing files across the channel is dependent upon the cost of the channel, the speed of the channel, and the size of the file. For each file there will be multiple “Link costs.” The link costs are described by:
Total_File_Link_#_upload_cost=price_per_second*file_size_in_bits/speed_in_bits_per_second.

WIPSS can perform decisions on which link(s) or channel(s) to utilize for a given file, and the time at which to propagate the file, based on the preferences that the user sets for a file.

This optional ability for the user to set preferences for the files enables the system to perform specifically to the users needs, and allows the user to set relative values to the data that is stored on the CS and PS systems.

e. Primary Channel Communications Methods

There are several possible methods to select the appropriate communications channel, and there are various methods for choosing, connecting, reconnecting and switching between channels. One of these methods is discussed below, although other methods could be used.

The methods for channel selection described in this section involve the designation of a primary channel. We define the methods for dealing with this process in the details below. We discuss first, when the WLAN is the primary channel what the operational methods will be, and second, when the WWAN is the primary channel. In these embodiments, we describe a situation where the WWAN channel is more widely available, but slower, than the WLAN channel which is faster, but has more limited in range and availability. (Although we discuss the selection between two channels, these methods can be extended to more than two wireless channels.)

WLAN Primary Channel

Where the faster, but shorter range, WLAN is the primary channel and WWAN is the secondary channel:
Then when a WLAN is detected, we automatically switch to this Wireless LAN and drop the WWAN (if established), or
Then when a WLAN is detected, we establish the connection to this Wireless LAN, but maintain the connection to the WWAN connection (if established) and that connection is switched to Standby. (Active/Standby model)

If the WWAN connection is lost, no immediate attempt will be made to reconnect when connection to the WLAN is established. However, if communications with both channels have been lost, attempts will be made to reestablish this connection:
Attempt to first establish communications on the primary channel, and then to establish communications on the secondary channel, and this involves time to search for the signal of the primary channel, or
Establish communications on the first signal detected. The first signal from either primary or secondary channel will initiate the establishment of a connection.
   WWAN Primary Channel

In this case, the wider ranging, but slower WWAN is the primary channel. If WWAN is the primary channel and the Wireless LAN is the secondary channel, then, when a WLAN is detected:
Then a connection with the WLAN will be established only when there is no connection established on the WWAN, or
Then a connection with the Wireless LAN will be established as a secondary channel. (Active/Standby model)
   No Channel is Primary

In this model, there is no primary channel and each channel is dealt with equally. At any given time, one channel may be designated as Active, and the other as Standby. A connected channel will always be designated as Active, but the Standby channel may be connected or disconnected. Active/Standby designations become situationally dependent.

Co-Equal/Situation Dependant Models

Lowest Price Model
1. Active channel is the one that costs the user the least per byte.
2. If a less expense channel becomes available, the PS unit connects with that channel, makes it Active, and changes the previously Active channel to Standby.
3. Assume that one channel will always be cheaper than another and scan for it.

Higher Speed Model
1. Active channel is the one with the highest throughput.
2. If a channel is found that has higher throughput, the PS unit connects with that channel and makes it the Active channel, and the previously Active channel becomes Standby.
3. Assume that one channel—no doubt, a Wireless LAN—will always be the higher speed.

First Available Channel Model
1. Active channel is the one that is first detected after a full disconnect.
2. Change channels only after a both channels have been disconnected.
3. No Active/Standby; Active or Inactive only.
4. Simplest model. No need for scanning for a channel to switch to. All the others require scanning for another channel and switching to it, at some point.

The Active/Standby capability could be further refined by the capability to turn off the Portable-Server's send capability. The PS would only receive information and would not send acknowledgments until the send capability would be allowed to function.

These methods address a number of inherent wireless problems by utilizing more than one possible wireless connection, which increases chances of accessing available data transport:
(a) Automatic attempts at reconnection when a wireless connection has been lost.
(b) Providing a user with a PS unit that is a logically equivalent extension of the person's enterprise system. When connection is down, the user has access to a server that, although it may not be fully current with the enterprise systems, provides the user with performance that matches that of a locally accessible server.

f. Lowest Purchase Price Model/Lowest Cost To Provide Model

Rationale: Most data communication in WIPSS model does not require “On-demand” service from a wireless communications carrier. The provider can allocate a communications channel when resource demand is low, and when demand is high, he can shut down the channel allocated to WIPSS data.

Wireless network providers know that a communications channel exists for a moment in time, and if an available channel-moment is not used, it is lost forever. The wireless network provider's preference is to sell that channel-moment to an “On-demand” customer, a person who just pushed TALK on their phone or computer. Therefore, if a carrier has a channel-moment available, and has no paying customer ‘asking’ to use it, it has zero value for that moment. That is the same value as an empty airplane seat as they close the doors for takeoff. WIPSS communications model uses those ‘empty seats’ and enables wireless network providers to offer bandwidth to users in the most effective manner. Each channel-moment can be used to handle a WIPSS packet. Network resources can be planned more based on overall daytime demand instead of peak demand.

(Providing resources on the basis of peak demand forces network planners to spend uneconomically for resources, while if resources could be put in place more on the basis of overall demand on a per cell-site and per minute basis, resources can be more economically planned for. Furthermore, network providers could produce additional revenue without putting in additional resources given that their network resources were put in place on the basis of peak demand. This model will allow network providers additional revenue at nearly no cost to them.)

The lowest price model can be further elaborated by:
If the CS provides a data file to the carrier, with a request that it not be sent until an unassigned channel-moment becomes available, then a value metric tells us the carrier could sell that incremental channel-moment at the incremental cost (i.e., unburdened cost) plus a nominal amount for profit. This is essentially a standby customer on an airline.
The amount of profit may be constrained by the competition presented by the 802.11b carrier who has more attractive data speed (bandwidth), offset by poorer coverage. In the airline business, this would be trains and busses.
The other thing that is happening is that CS is sending information to the PS that may never be needed, i.e., ‘pre-positioning’ information with the user, before they want it. If an unassigned channel-moment costs one-fiftieth as much as an “On-demand” channel-moment, then the system can send 50 times as much data for the same cost. If >2% of that information is ultimately “important” then we are ahead. If only 1% is ultimately important, then we bet and lost, but we guaranteed that only current information was available, compensated for the uncertainty of what might be “important”, and provided latency-free access, all at little additional cost.
An added benefit of this approach is that independence is provided from the enterprise, yielding “survivability” of the user's mission despite the failure of the Central-Server, the enterprise, or the wireless infrastructure.
Day versus Night pricing is an addition to this model. The network provider could 5 encourage enterprises to consider delaying large files to keep from “clogging the pipes” during the daytime.

g. Server Couplet—Two Halves of One Logical Server

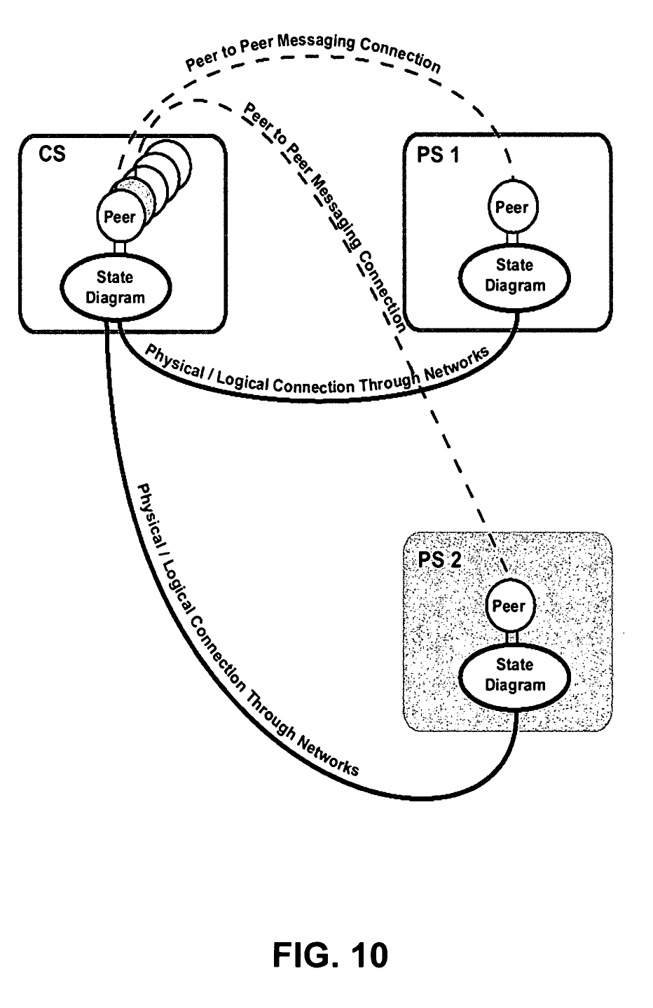

As shown in FIG. 10 (Server Couplet), this invention uses two physically separate, but logically connected computers, wherein one computer is the logical equivalent of a subset of another larger machine. The attributes of this invention are:
Wireless connection: Connected through a sporadic wireless connection network. The communications system manages this connection.
Equivalency: The aspects of the Sync-Seeking servers that are synchronized and the methods that perform it.
The CS runs multiple peer processes. Each peer process corresponds to a peer process running on each PS. The CS “knows” the identity of a PS through an identifying process running on the PS. The PS “knows” the identity of a “CS” through the corresponding peer process running on the CS. Each process is harmonized with the other and each has available the history of actions performed between the two processes. That is, each peer process “knows” its twin in part through shared history to which only they have access.

h. Sync-Seeking System

That portion of the CS related to a specific PS, together with the PS, operate through attempting to maintain equivalency between the respective data sources. A change in data that occurs in one server generates the processes to propagate that change to the other server.

At the two ends of this paired server arrangement are peer processes that communicate to maintain communication and data synchrony. The peer processes manage communication synchrony using the methods discussed above. It also manages data synchrony using the methods and capabilities described below.

The method of the paired peer processes—one process in the PS and one peer process for each PS that the CS supports—may perform the following services for the system:
Authentication of the PS to the Central-Server
Authentication of the CS to the Portable-Server
Determination of the speed of the communications channel
Establish over-the-air encryption sequence
Establishes connection modes for bi-directional data transfer
Establishes data transfer modes and initiates data transfer activity.
Reestablishes data transfer models when connection has been broken and reinitiate data transfer activity
If enabled, select files for transfer based on priority, file size, channel cost, and communications channel speed.

i. Synchronous Database

Databases may be established in the CS and the Portable-Servers. Processes on each side detect any changes to the data in either database, which is reported to the peer process on the affected server side. That peer process then sets up a data transmission immediately, or through scheduling, with its peer on the other side. Processes that detect changes to the data—that is, detect asynchronies—communicate through the peer process. This enables different types of databases to communicate to each other and their contents to remain in sync.

j Synchronous File System

The file system procedure is similar to that of the database, with the exception that the data is organized in a file system. The peer to peer processes enables data replication between data stored in a file system in one Sync-Seeking server and in a data system in the other side of the Sync-Seeking server. The “data system” can include a corresponding standard file system or a data base.

k. Synchronous E-mail

E-mail operates in a similar manner as the synchronous database. Alternately, the PS could operate directly with the mail host.

l. Pipeline Mode

This invention can include the capability to enable the user to connect in real time through the wireless system. The Sync-Seeking server capabilities, other than security and encryption, could essentially be bypassed. For example, if a user were connected to the Internet web using an HTML browser, the services of the Sync-Seeking servers would be unnecessary. In this case, when this Pipeline capability is engaged, the Sync-Seeking server capabilities are not engaged. Similarly, Instant Messaging could be handled this way. The wireless carrier would recognize this traffic as “On-demand” and process (and invoice) accordingly. See also Table 3.

m. Distributed Units; Autonomous Operation

The PS units operate autonomously in that they normally do not require user intervention. The PS operates in “POST” operation with the Central-Server.

The WIPSS system not only looks at the cost per second of the transmission link, but also accounts for the file size and transmission speed. Additionally, the value of different files is important. The WIPSS system has the ability make decisions based on upload/download cost and user set preferences. Different files cost more to transmit on different links and the intelligence of the WIPSS systems makes it possible for the user to utilize the most appropriate transmission means for each file.

The WIPSS system provides notification to the varying display devices of CS and PS status, wherein each PS can relay information to display devices in a proprietary format, such that the display device, while utilizing known software, can interpret and communicate to the user the status of the system.
The PS will utilize a known (and standardized) WIPSS EP Port for accessing varying types of display devices.
Display devices will utilize cross platform software components to access the proprietary information sent across the IP Port.
Cross platform software components—i.e., written and based on a standard “portable” language like J2ME (Java), MExE (Mobile Station Application Execution Environment), BREW (Binary Runtime Environment for Wireless), etc.—enable the user to select a variety of modem computing platforms as the display device.
Network channel/link information can be provided to the user.
The user can control the PS and set user-definable preferences as needed.
Specific and unique IP Ports can be utilized to insure that the PS will always know the mechanism for notifying the display device(s), of which there may be several different display device each of which may have a different IP address.
Any cross platform applications or software will run in a “background” mode on the display device, if desired, so that the user can access other display device functionality.
The cross platform applications or software will ‘listen’ to the known IP Port waiting for the system to notify the application.
The EP Port enables the display device to ‘awaken’ the appropriate software application/function when data is received on the known and specific Port.

n. Integration with Other Enterprise System Services

This technology can be integrated with other enterprise system services and other computers. Usual methods for performing that integration are not detailed herein.

The WIPSS system enables a user to access the CS via a web-based (HTML/HTTP) interface enabling the user to utilize the CS as a security proxy and application proxy to access otherwise private systems such as secure corporate or enterprise network systems. This is used for the purposes of initial provisioning, re-provisioning, and other purposes. (For example, utilizing CS to CS intercommunication and “autonomous configuration” could uniquely enable the WIPSS system to allow users to migrate between carrier/operator solutions. In other words, a user could subscribe to a new service on a different operator's system and utilize this feature to transfer his or her data.)
The user can directly connect to the CS via HTTP from a standard web browser (e.g., MS Internet Explorer, Apple Safari, Opera, or Netscape Navigator).
The user will access the CS via HTTPS security means including password protection, encrypted transmission, and secure web pages (HTML content).
The user can do this from any public or private display device or computer terminal that supports a standard web browser.
The CS system will proxy the user into the enterprise, business, corporate or otherwise private network system.
The user can utilize the data on the CS, such as account and password information, to access the aforementioned private network systems without having to access a variety of different security code systems.
When appropriate and when the data content is compatible, the data files contained on the CS can be accessed and viewed via the user across the HTTP link from the user's system to the CS.
The CS will operate as a security proxy for the user by intercepting security prompts and password entries and fulfill these requests on behalf the user.

o. Inter-Server Data Security

As discussed earlier, data transfers are initiated through Sync-Seeking processes. A change in data—an updated file or database record, an e-mail sent or received—produces a state in the system to initiate and complete a data transfer to the Sync-Seeking server. In addition, data security—authentication and encryption—operates in a similar manner as well, and as such, will be included in the description.

Authentication and encryption techniques may involve the following:
ES/DD (end to end) encryption domain: This encryption is between the Enterprise and the employee's display device, and is an end-to-end encryption. Public key encryption is the likely candidate technique in this domain since it provides non-repudiation. Actual use would be the responsibility of the user and the ES system administrator. Its use would not encumber the other WIPSS security systems.
CS/PS and PS/DD encryption and authentication domain: This encryption and authentication system is automatic and takes place without intervention by the user. The encryption system is peer-to-peer and not part of the public domain. The CS and PS authenticate each other using a private application-level protocol, essentially using shared secrets that are both not reciprocal, and also that change often (unlike cellular telephone implementations), combined to prevent spoofing. The secrets are not transmitted over-the-air, but rather are derived from the initial provisioning and subsequent random events. The identity of every PS managed by the CS is listed, and the PS “knows” the identity of the CS that manages it. The responsibility is entirely that of the WIPSS.
WWAN to PS encryption: This is the encryption that the cellular provider and the radio within the PS would share between them. This is an automatic over-the-air encryption system, over which WIPSS has no control.
WLAN to PS encryption. This is an optional over-the-air encryption between the PS and the WLAN access point, over which WIPSS has no control, but the PS would be able to accommodate its requirements.
ES/CS encryption. In some cases, the connection between the CS and the ES may not be secure. The CS and ES system administrators would provide encryption and authentication mechanisms (VPN) to insure the security of the transmitted data and prevent unauthorized access.
WLAN router to CS encryption. This is optional wire-line encryption between the CS and the router that controls the WLAN access point. Responsibility would fall to the WLAN provider, but not required by WIPSS.
WWAN Mobile Switching Office to CS encryption. This is optional wire-line encryption between the CS and the switch that controls the WWAN network. The use of a VPN is currently offered by the WWAN carriers. Not required by WIPSS.

p. Expanded Functionality from ‘Peered’ Central-Servers

Central-Servers may be instructed to seek information from other Central-Servers, thereby learning things of importance to owners of Portable-Servers. A specific example is the ability to share the individual “Transmitter Site Knowledge Bases”(TSKB) as new sites are discovered and existing sites removed from service. Each Portable-Server refers to its TSKB when looking to establish communications. If the PS had no idea of where it might be, although it knows where it was recently, it would have to initiate a random search of both cellular and WLAN channels. Normally, the PS knows where it has been recently and can ‘learn’ its approximate location from inquiring of the cellular system, (cellular systems often provide coordinates as learned from time-of-arrival calculations) then search a limited number of choices. This limits the searching that must otherwise be done to establish communications. The spontaneous peer to peer information sharing ability of Central-Servers may also be used for distribution of files, thereby offloading the enterprise system.

Finding Wireless LAN connections is more difficult than finding WWAN connections, and uses more battery power. This is because WLAN access points typically have low RF output power and hence, limited range of operation. Also, there are more RF channels to be searched. The WIPSS PS unit improves the probability and speed of finding an access point by maintaining a database of possible network choices, thereby saving time and power consumption over that used by a random search. This is advantageous, but is multiplied in effect by having the Central-Servers share the knowledge learned by their respective Portable-Servers. In this manner, each PS has a database of possible choices as complete as any other in the world. As knowledge is assimilated by one PS, it is learned by all.

q. Discussion of Advantages

The WIPSS solution can make use of inexpensive airtime. This is because the carrier has the right to “defer” the packets until excess capacity is available. This is similar to filling empty seats on an airplane with “standby” passengers. The reason this is achievable is that the system breaks each message up into packets that are routed somewhat independently to the other Sync-Seeking server. The reason this is acceptable is that no human at the other end is waiting for those packets. Not only can the packets be deferred, but they can also be spread over time. This increases channel usage in a multi-channel communications system, without increasing the latency as seen by the users. This technique of separating messages into smaller packets and sending these packets through the network during the breaks in normal voice messages, hides delays introduced by the process, so that they are not noticeable to the user, because the user sees only the complete restored message.

An additional benefit to the carrier would be the lack of necessity to provide seamless, roaming coverage. For example, currently wireless networks must be able to hand-off connections between access points during a call without dropping the call. Anyone who has ever made a wireless call while moving has noted that this system operates correctly most of the time, but not every time. The WWAN carriers have devoted significant resources to making and continuing to make this system operate. A side benefit of WIPSS “As-available” technology will be that carriers need not provide seamless roaming since the user is usually not directly connected to the wireless network, but is connected through a Portable-Server; the CS/PS connection can be thought of to exist at the “packet” level, rather than “session” level. The user would probably never be aware of a connection break. When a wireless network connection break would occur, WIPSS technology would immediately and automatically seek a new connection, obviating the need for seamless roaming. Users would experience an “On-demand” continuous connection with their Portable-Server, but the carriers need provide only “As-available” airtime.

In preferred embodiments, the solution will appear as fast as, or quicker than, any other approach. This is because (1) the Portable-Server is always looking for one or more networks to communicate over, (2) information is pre-sent in anticipation of its need, and (3) the slight delay caused by the deferrable nature of the transmissions will never be ‘seen’ by the end-user.

The technique of pre-sending (pre-positioning) information on the Portable-Server goes far beyond simple “Pre-caching” used on the Internet today to put web servers at the “edge” of the Internet so as to deliver web pages faster. In the WIPSS implementation, it is the power of the Central-Server seeking out specific information of usefulness to the user of the Portable-Server, and pre-sending that information to the specific person when inexpensive air-time is available, that makes the system work so well and so inexpensively. The system is moving massive amounts of data at very low cost because it is moving it in anticipation of its need using otherwise wasted airtime-moments. The system is also better in that it works in both directions. In the inbound (toward enterprise) direction, files changes are sent from the PS to CS without the requirement to first “log-in” to the enterprise system or application that handles the specific data. The CS subsequently “Logs-in” and updates the enterprise system or application.

The WIPSS solution allows the powerful agents to automate much of a user's communications requirements. The WIPSS “POST” technique can go beyond “Pull,” “Push,” “Dock,” and Internet FTP techniques to provide reliable delivery in the difficult RF environment. The POST design assumes connections are sporadic, and provides queues based on specific user needs. When a connection occurs, the POST quickly executes its processes on both Sync-Seeking servers (Portable-Server and Central-Server). See FIG. 5 (Connection Model Through WIPSS).

In the event a user needs to Instant Message or ‘surf’ the Internet, POST switches to a real-time connection (pipeline) mode. POST is IM-aware: Instant Messaging requires that once one is connected, that “presence” be continually communicated to one's “buddies.” POST confirms not only that the Portable-Server is connected to the Central-Server, but also that a laptop or other display device is turned on and linked to the Portable-Server, i.e., a human is present. The corresponding process on the CS signals lack of presence whenever it loses communications with the Portable-Server, or is told by the Portable-Server that no display device is active.

Establishing “Instant Messaging” with often disconnected units, wherein the base unit (Central-Server) acts as a stand-in for the mobile unit and logs in and out of the Instant Messaging Server, will follow rules similar to below:
a) Not connected to mobile unit; Log out.
b) Connected to mobile unit, but human being is not present; Log out.
c) Connected to mobile unit, and human being responds to interrogation; Log in.
d) Connection lost, or mobile device not responsive; Log out.
e) At the mobile end, notify user whenever connection is established/lost.

The use of a Central-Server solves many of the problems with corporate use of Instant Messaging, for example, the required archival logging of traffic transfer to and from various IM systems, enforcing security restrictions with respect to sending attachments, encryption, etc.

Some of the various modes of operation are shown in Table 4.

TABLE 4
Modes of Over-The-Air Operation

| | CONNECTIONS | | |
|---|---|---|---|
| REQUIREMENTS: | No Connection | WWAN | WLAN |
| File transfer | POST | Yes | Yes |
| Mail | POST | Yes | Yes |
| IM | No | Yes | Pipeline |
| Surfing | No | Unlikely | Pipeline |
| Voice | No | Yes (cellular) | No |
| VoIP | No | No | Pipeline |

This algorithm can be further modified by cost considerations, especially when additional connection choices exist. For example, one might consider if in a ‘home’ cellular (WWAN) area or ‘roaming’ cellular area; is a WLAN available that is free or is a subscription required (and if so, are we subscriber?). Also, the traffic queue depth will likely be a consideration.

The WIPSS solution has increased reliability over the RF channels because of the extensive use of diversity techniques: (1) two separate networks are used, using different frequencies and modulation formats over separate antennas; (2) by sending information opportunistically in anticipation of its later need, we are using time as a diversity technique; and (3) we are anticipating the owner of the Portable-Server will move over time to a different (hopefully better) location, resulting in space/location diversity.

We call this simultaneous use of multiple independent diversity techniques “Multiple Orthogonal Diversity.” This is a technique of continuously attempting, by simultaneous use of three or more of the following, to maintain wireless logical connections and improve its overall reliability:
a) Time diversity, by re-sending a packet later, to overcome co-channel interference;
b) Antenna (space) diversity, by using physically separated antennas to overcome propagation dead-spots caused by multi-path reflections;
c) Network diversity, by always attempting to use two or more disparate networks in parallel, to overcome network loading or other problems;
d) Frequency diversity, using two channels separated by an octave, to overcome frequency-selective fading;
e) Location diversity, using the natural movement of the person carrying the one end of the communication path, to relocate out of weak signal areas.

The WIPSS solution can also extend battery life because no display is used—a major user of power. Also, the use of the self-learning Transmission Site Knowledge Base (TSKB) will allow conservation of transmitter power, and increase throughput when high-speed facilities are available. The TSKB makes use of location information learned from the cellular system itself (typically from time-of-arrival calculations) and/or GPS information from an onboard or nearby GPS unit. The TSKB is updated regularly based on queries by the Central-Server of other Central-Servers, each of which is learning about possible transmitter sites from its respective Portable-Servers, as these sites are observed by the Portable-Server as the units travel around.

This solution addresses all known security issues through the use several techniques: Dual encryption is used: a form of public-key encryption (PGP, PKI, ViaQuo, or similar) is used for end-to-end encryption between the enterprise and the Display Device, and a special additional crypto system for the over-the-air links between Central-Server and PS and from Portable-Server to display device.

WIPSS could take responsibility for supplying and enforcing the proper authentication and encryption techniques because the users cannot be counted upon to do it. Ideally, the enterprise would send out files encoded with the Public Key of the intended recipient, which could properly be decoded only by display devices owned and controlled by the recipient. (Public Key could provide the desirable ‘non-repudiation’ feature.) The Central-Server could look for file changes by comparing hashes of files.

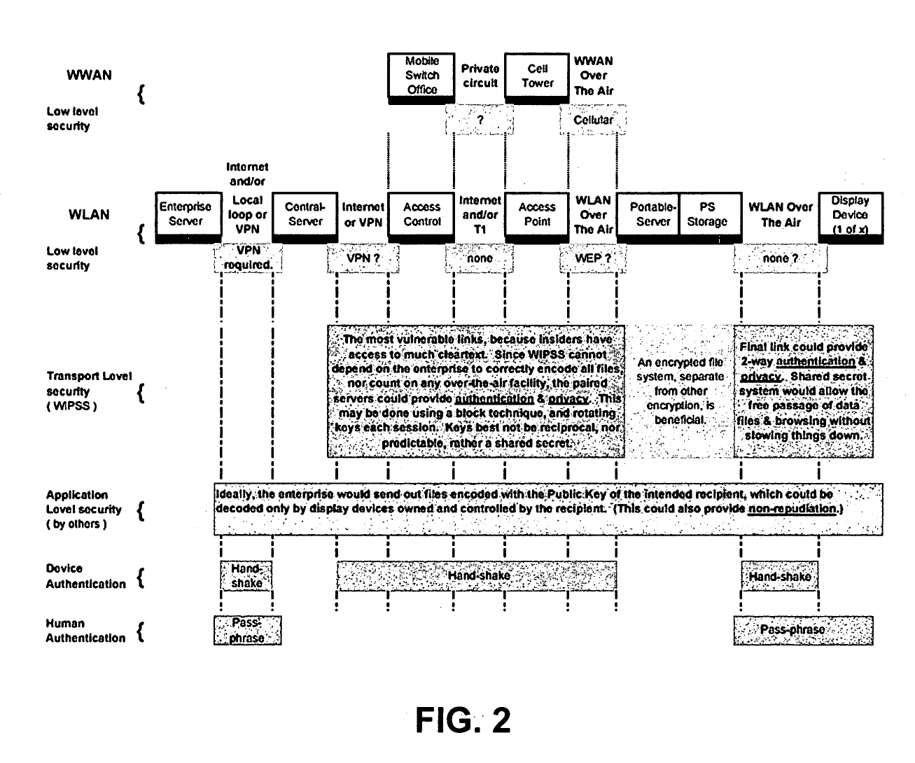

The over-the-air link between paired servers is the most vulnerable to attack, because insiders have access to much clear-text and corresponding over-the-air cipher-text. Since WIPSS cannot depend on the enterprise to correctly encrypt all files, nor count on any over-the-air facility, the paired servers could advantageously provide authentication and privacy. FIG. 2 (Security Model) shows the overlapping security.

A wireless communications model can beneficially use security methods designed to:
Prevent transfer of cipher keys across the network and enable true peer-to-peer security without losing the capability to transfer data across a wider network using standard encryption methods.
Utilize methods of authentication that reduce the likelihood of catastrophic failure that would enable an intruder full access to data if security had been compromised.

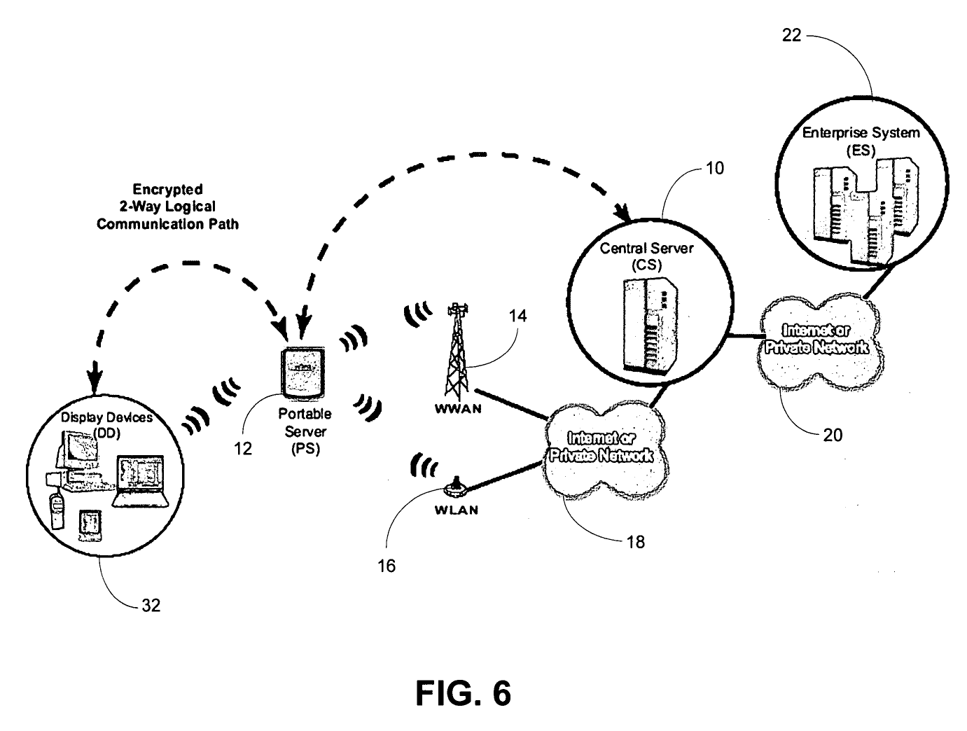

Because the Portable-Server and CS authenticate each other, the resulting data may be safely transferred through the firewall into and out of the enterprise. As an additional security feature, the enterprise's Chief Information Officer (CIO) could be able to remotely erase files on a Portable-Server. See FIG. 6 (WIPSS Security).

Note: the PS and the CS are usually “connected” in the background without using airtime. The WWAN carrier and WLAN equipment each typically maintain logical connection status with all mobile units without charge. (This is how a cellular system knows where you are.) These carriers also maintain a logical connection from their terminus to the Central-Server, also without charge. (The wireless carrier maintains an IP address for the PS without charging airtime.) Logically, the communication channel can always be “on,” that is, WEPSS is in constant communication with the carrier's network, but there is no charge. During quiet periods—when no data is being exchanged—the PS will periodically send a short packet to the CS indicating that the PS is connected and operational. The CS and PS verify each other's operational status using trivial amounts of airtime. There is a charge for this. WWAN wireless packet data is charged based on kilobytes transferred through the network. It is not charged on the basis of an “airtime” connection charge, as with voice. Publicly accessible WLANs generally charge a fixed price for unlimited usage over a period of time, e.g., a monthly charge.

One purpose of the Central-Server is to “look like” the user to the various file servers the user is authorized to access, i.e., the file server should believe the user has logged-in from his or her computer, and is requesting information that the user is entitled to access.

The following are exemplary types of users:
Employees of an enterprise in which the enterprise has its own Central-Server, located in-house. Employees are provisioned by the IT department, and have access to all authorized corporate files.
Employees of an enterprise in which the enterprise has its own Central-Server, located at an outsourced facility. Employees are provisioned by the IT department, and have access to all authorized corporate files.
Employees of an enterprise where the enterprise does not have its own Central-Server. Employees provision themselves, using software provided by Rosetta-Wireless. They have access to corporate files, as if a ‘remote’ user, plus access to Internet resources.
Employees of a small businesses—businesses that do not even have an enterprise system. This includes small companies, sole proprietors, and individuals. If one is a member of this fourth exemplary user type, the Outsourced Central-Server (OCS), once provisioned by the user, can access the user's home computer, spouse's computer, partner's computer, subscription Internet resources, etc. The user would rent OCS service from a supplier along with airtime.

Example of the later user type: Two people form a PR business, consulting to disparate clients across the country. They work out of their respective homes, and travel extensively. Client materials are shared. Each partner would sign up for WRPSS at their local cellular carrier, take the unit home with them, and then provision themselves for access to their home-office computer, selected directories on their partner's home-office computer, and certain Internet subscriptions and other resources. Now whenever and wherever they turn on a laptop or PDA, they would each see an up-to-date listing of all shared files, as if they were sitting next to each other. They could review and comment on each other's proposals and PR plans. They could have a common contact list, and would have instant access to each other's schedules—to set-up joint customer visits or calls. They would now have a virtual office they share, and a virtual file server they share.

All four exemplary types of users listed above can achieve the objective of duplicating the office experience when away from the office. The CS could be physically located either within the enterprise firewall, or outside. Table 5 shows four combinations of ownership and location.

TABLE 5
Central-Server Location

| | | Owned by |
|---|---|---|
| | | OCS Service |
| CENTRAL-SERVER | Owned by Enterprise | Provider |
| Located within enterprise | “Direct installation” | — |
| Located elsewhere, access to | “Enterprise, outsourced” | “Individual, |
| enterprise | | enterprise |
| | | employee” |
| Located elsewhere, no | — | “Individual |
| enterprise | | small business |
| | | user” |

“Direct installation”: The enterprise has installed a WIPSS system, and Central-Server resides behind the enterprise firewall; the CS encrypts files before forwarding to the WWAN and WLAN networks. Conversely, the CS decrypts incoming data. This approach provides the maximum control to the CIO.
“Enterprise, outsourced”: The Central-Server can be located outside of the enterprise's firewall; it resides at the facility of the Outsourced Central-Server provider. Providing WIPSS services as outsourced is done much the same way as doing the payroll is out-sourced. The enterprise may treat the user as logging in through a VPN, just as a direct remote user would be. Files to be sent out of the enterprise would be first encrypted (with the public key of the intended recipient) and then forwarded to the Outsourced Central-Server for delivery.
“Individual, enterprise employee”: This is the similar to the one above in operation. Here the enterprise has not implemented its own WIPSS system, so the employees have taken the initiative to equip themselves and rent OCS server service.
“Individual small business user”: A fourth approach is where the user is not part of any large enterprise, i.e., is part of a small business or is a private person. An Outsourced Central-Server service is similarly used. It resides at the facility of the Outsourced Central-Server provider. The Outsourced Central-Server can access the user's office PC, home computer, spouse's computer, partner's computer, subscription Internet resources, etc., and in this case becomes a pseudo enterprise server for the small business or private person.

The PS and CS both provide billing information to a depository so that appropriate sharing of revenue can be done between the providers and users of the various wireless networks. The sameness of the data provided is a validation that no unit is attempting to spoof the identity of a PS or CS. This also provides confidence to the providers of airtime and other services that the billing information they are receiving is correct. Previously no customer premise equipment could be relied upon to provide its own billing information; WIPSS makes this possible, saving the various carriers and service providers the expense of installing separate systems for tracking these very small transactions.

In a similar way, the PSs can assimilate the learned knowledge of other PSs through their respective CSs. When a PS acquires data through its operation, it passes that data to its CS. The CSs share certain data among themselves and shared data base repositories, so that what one “knows” they all know. The data is passed to all other PSs from their paired CS, and the local knowledge base updated. This behavior of Central-Servers, learning from one another by updating databases of shared knowledge, and then passing the knowledge on to the PSs, provides a powerful tool for ubiquitous information dissemination. For example, individual Portable-Server units add coordinates of locations of accessible transmitters (access points) based on their field experience, as well as frequencies supported and other information that will make it easier to access and authenticate in subsequent visits. New additions are communicated to the Central-Server. The Central-Server then communicates to other Central-Servers and/or a repository database. In time, all Portable-Servers receive the updated information (or at least the part of value to them). It is the Sync-Seeking nature of the PC/CS relationship and the shared knowledge base of the CSs that enable this facility.

Specific CS/CS relationships can also be formed; it may be advantageous to split or merge CS databases as changes in situation (marriage, employment, etc.) may deem desirable.

The columns in Table 6 describe differences of results between WIPSS and other approaches for key qualities desirable to users and their sponsoring organizations.

TABLE 6
Comparison of Exemplary WIPSS Functionality to Other Systems

| FUNCTION | WIPSS | OTHERS |
|---|---|---|
| Uniform/ | Provides consistent information, | Other approaches are limited to the most |
| Ubiquitous | everywhere, while holding it secret. | recent synchronization. |
| Control | WIPSS protects information from theft, | Other approaches transmit securely, but |
| | by storing it still encrypted. | store decrypted information on display |
| | | device. |
| Accountability | Provides up-to-date information about | Other approaches limited to the oldest |
| | all persons to all authorized persons. | synchronization. |
| All My Files | WIPSS eliminates the requirement to | Other approaches use inquiry/response |
| | personally keep track of all your | technique to deliver snippets of |
| | documents, orders, incoming e-mail, | information. No other approach |
| | ‘sent-mail’ folder, history, etc., between | attempts to keep all files with the user. |
| | various machines used daily (home | No other approach provides consistent |
| | computer, tablet, PDA, laptop, office | information between various devices, |
| | computer, etc.). | automatically. |
| Automatic | WIPSS prevents errors by providing | Other approaches require manual |
| | “hands-off” replication and back up of | synchronization, and few support back |
| | all information. | up of information on display devices. |
| Instantly | WIPSS eliminates latency by pre- | Other approaches deliver snippets of |
| Accessible | positioning information. | information, after acquisition and |
| | | transmission delays. |
| Uninterrupted | Dual-band operation works in RF dead- | Other approaches are wirelessly |
| | spot areas, and inside shielded | dependent (not “wirelessly- |
| | enclosures. | independent”) |
| Survivable | Replicated information lets personnel | When enterprise servers go down, server |
| | continue work when enterprise servers | access terminates. |
| | go down. System updates upon return. | |
| Simple | WIPSS' operation is ‘just like at the | Other approaches ‘get in the way’ of a |
| | office.’ | person trying to make a decision. |

TABLE 7
Exemplary WIPSS' Advantages to the User

| | Wireless PDA or | | |
|---|---|---|---|
| | Blackberry-type | PDA or laptop | PDA or laptop with |
| Data Management Issues | pager | without WIPSS | WIPSS |
| Accurate schedules? | My Schedule | My Schedule | My Schedule + all co- |
| | | | workers, all up to date |
| Simplified inquiries? | | | Yes |
| E-mail attachments? | MS Office (partial) | | Yes |
| Edit attachments? | MS Office (partial) | | Yes |
| ALL files with you and up to date? | e-mail only | | Yes |
| Survivable: Continues to work | | | Yes |
| when enterprise network is down? | | | |
| Latency-free (apparent latency) | e-mail only | | Yes |
| Verification of file delivery? | e-mail only | | Yes |
| Wireless speed | 2 G | | 2.5 G + WLAN |
| Display data on any device | | | Yes |
| appropriate at the moment? | | | |
| Works “Just like at the office”? | | | Yes |
| Same file versions on all devices? | | | Yes |
| Automatic replication? | e-mail only | | Yes |
| Information automatically kept | e-mail only | | Yes |
| current? | | | |
| Files in native format? | | | Yes |
| Very Large Storage capacity? | | | Yes |
| Automatic file back-up? | | | Yes |
| Simplify IT department support? | | | Yes |
| IT department maintains ultimate | | | Yes |
| control of information? | | | |
| Prevents decrypted file storage on | | | Yes |
| client's computer? | | | |
| Wireless “independent” - i.e., | | | Yes |
| continues working in poor RF | | | |
| areas and shielded enclosures? | | | |
| Optimizes channel loading of | | | Yes |
| backbone carrier? | | | |
| Multiple channels provide | | | Yes |
| redundancy and least-cost routing? | | | |

The columns in Table 7 represent what features are available via a wireless-computing device, via a non-wireless device, and via a WIPSS.

2. Central Server (CS)

In the preferred embodiment, the CS is a separate server device that may physically exist anywhere on the Internet network, or behind the enterprise firewall. The advantage of being outside the enterprise firewall in that the CS can then access multiple enterprise systems to bring across the disparate information needs of the end-user, i.e., subscriptions, Instant Messaging, home computer, Internet broadcasts, etc., while still being able to access authorized enterprise information via VPN or other connection.

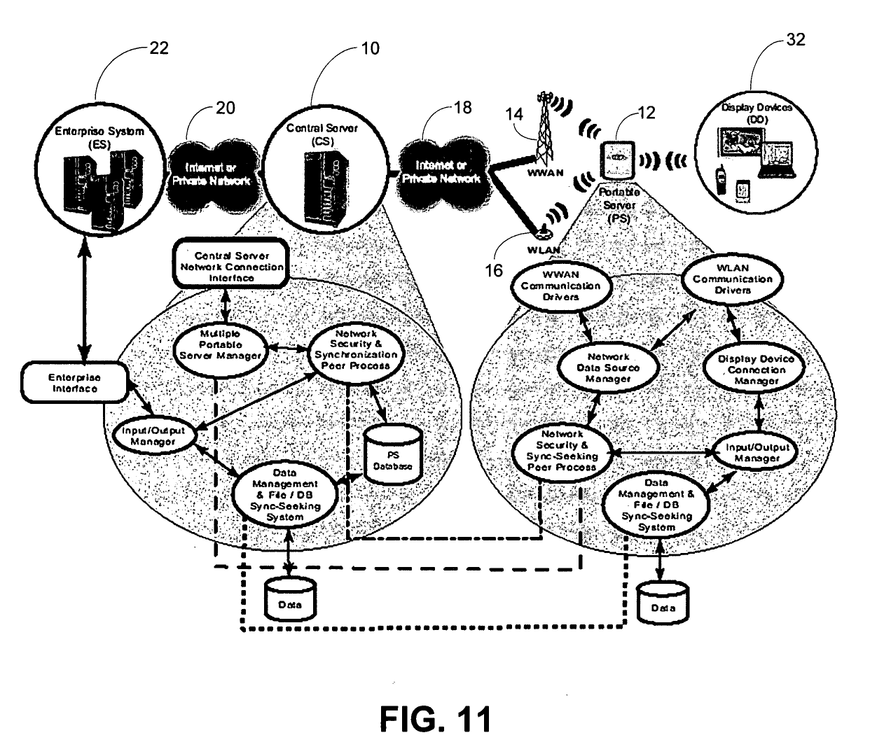

FIG. 11 (Relationship Between Central-Server and Portable-Server Processes) serves as the focal point for the explanation of this technology.

The CS has several components that support the data and security system processes. In some cases, these components have peer-to-peer communications with processes in the PS. This discussion focuses on the capabilities of the specific components shown in the CS.

Multiple PS Manager:

Interfaces with the PS communications links and the network, e.g., Internet.
It has a peer-to-peer communications link with a PS component as shown by the long dashed line.
Identifies each PS as one of its listed members.
Handles the changes as each PS's network address changes.
When a PS has two (or more) addresses, notes which address is “Active” and which address is “Standby.” “Active” address has data transferred from and to it; “Standby” address receives occasional messages requesting response from the PS to determine if PS is still using that address—Becomes the new “Active” if the previously “Active” address fails to acknowledge a packet.
Manages the connections with all PS on its list.
Communicates with PS Network Security & Sync-Seeking Peer Process.
   Network Security & Sync-Seeking Peer Process:
Operates at a higher communication level than the Multiple PS Manager.
Receives communications from the Multiple PS Manager.
Acts as the peer process to the PS process, as shown by the dashed circles communications link.
Manages one PS at a time.
Performs Authentication, Encryption, and Decryption.
Resynchronizes with PS peer on any communications break and reestablishes packet data flow from mutually defined break point.
Resynchronizes with PS peer process: encryption keys, and packet data transmission and receiving management.
Pass through data requests, related to Sync-Seeking, to the Data Management & File/DB Sync-Seeking System.
   I/O Manager:
Brokers requests for data input and output with (1) enterprise, and (2) Data Management & File/DB Sync-Seeking System.
Acts as a conduit for the sources of messages and data.
Does not communicate with its PS counterpart.
Manages data and message flow.
   Data Management & File/DB Sync-Seeking System:
Maintains data equivalency with its peer in the Portable-Server(s) (as shown in the figure by the dashed squares).
Manages data related to each Portable-Server.
Stores and retrieves data.
Initiates the data transfer to the Portable-server(s) when it receives data through the I/O Manager from the Enterprise. Data received can be files, data base records and updates to records, E-mail.
Database of the data specified for each PS maintained by this process.
   4. Portable Server

The Portable-Server (PS) unit may be provided as a small computer that is able to connect with various devices such as PDAs, laptop computers, set-top boxes, tablets, home computers, etc., as well as cell phones and various ancillary devices.

The PS may communicate on one or more RF networks (traditional networks as well as Mesh networks), which may be either one-way or two-way, using either its own RF resources or those of other devices. The PS may use hardware, software, and or firmware to perform its various functions, as described herein.

The PS, like the CS, initiates data transfers to the CS based on achieving equivalency. If data is added to or changed on the PS outside of the Sync-Seeking process with the CS, that will initiate a data transfer from the PS to the CS.

Network Source Manager:

Receives data and messages from WWAN and WLAN connections.
Sends data and messages to WWAN and/or WLAN connection.
Maintains the data transfer and connection states with wireless connection and CS through the network, e.g., Internet.
Manages channels, organizes and sequences packets.
Manages the network address of the CS.
Maintains the updates to the network address(es) of the Portable-Server.
Communicates data and messages from the CS to the Network Security & Sync-Seeking Peer Process.
   Network Security & Sync-Seeking Peer Process:
Communicates with its counterpart in the Central-Server.
Identified the PS to the Central-Server.
Performs the same data equivalency operations as its CS peer.
Communicates to the Multiple PS Manager, however, but does not receive messages from it. All messages are from the CS peer.
   Display Device Connection Manager:
Interface to the Display Device or Display Devices
Authenticates Display Devices and Display Device users. Both should first be authenticated to access PS Data
Sends data related requests to 1/O Manager
Receives data from the I/O Manager
   I/O Manager:
Operation similar to CS counterpart
Brokers requests from Network Security & Sync-Seeking Peer Process and the Display Device Connection Manager
   Data Management & File/DB Sync-Seeking Process:
Operates similar to the CS peer process
Communicates with its peer
   5. Operational Scenarios

Four scenarios that illustrate the operation of the system are set forth below:

Scenario 1: E-Mail Sent to CS for Delivery to a Portable-Server

E-mails that arrive at the CS will be delivered to the appropriate Portable-Server. The e-mail arrives through the I/O Manager and is transferred to Data Management & File/DB Sync-Seeking System. This process translates the e-mail address into the PS identifier and stores the e-mail with the PS identification information. Furthermore, this initiates the Sync-Seeking procedures to migrate the e-mail to the identified Portable-Server.

The Data Management & File/DB Sync-Seeking System initiates the data transfer. It queues the e-mail for transfer with the I/O Manager.

The I/O Manager delivers the e-mail as data with the delivery information to the Network Security & Sync-Seeking Peer Process. The peer processes—with its peer at the other end—manage the transmission and verification of the data to the Portable-Server. The data packet flow is managed by the Multiple Server Manager.

At the PS end, packets come through one of the connections to the Network Data Source Manager that in turn passes the data to the Portable-Server's Network Security and Sync-Seeking Peer Process for assembly and acknowledgments. The e-mail is sent to the I/O Manager that in turn sends it to the Data Management & File/DB Sync-Seeking System for storage.

Scenario 2: An Update to a File Appears on CS and the File is Shared by More than One Portable-Server

In this instance, a data transfer would be initiated when a file has been updated. In addition, more than one PS has access to that file. Therefore, the change should be migrated to each PS that has that file as part of its accessible data. In this case, the Data Management & File/DB Sync-Seeking System initiates a data transfer to each of the applicable Portable-Servers. The file information indicates every PS that has access to the file. The system can distribute the file to each PS one at a time, or can distribute the file to each PS simultaneously. The simultaneous file transfer approach is preferred because of the fragile nature of the connections from the CS to the PS.

Scenario 3: E-Mail Transfer from PS to CS with Multiple Communications Breaks, Using Both Channels to Transfer Data

An e-mail for sending has been generated in the PS; thus, the message (plus any attachments) is migrated to the CS for delivery to the mail server for propagation to the recipient(s). In this scenario, the PS will encounter multiple connection breaks and will be connected to more than one channel. All through this, the packets of the e-mail will be transmitted to the CS without intervention from the PS user.

The initiation of the e-mail transfer process is the same as in the case with the CS. However, unlike the CS, the PS manages the wireless connection. Furthermore, the PS chooses the channel over which the data will be sent (and packet acknowledgments received). That is handled by the PS's Network Data Source Manager.

As in the case of the CS, the 1/O Manager sends the e-mail for sending to the Network Security & Sync-Seeking Peer Process that in turn manages sending the data. When a connection has been established and equivalency of all peer processes attained, the process sends the e-mail in packets to the Network Data Source Manager, which in turn sends the packet through the Active channel. When a connection break occurs and the PS finds another connection channel, a reconnection procedure takes place (as discussed earlier) and resynchronization of all peer process starts by re-sending the packets beginning from the point where its peer in the CS indicated it had received the last uncorrupted packet. With each break and reconnection with the PS, the CS's Multiple PS Manager maintains continually changing addresses of the PS and can receive information about the characteristics of the new connection. This can include whether the connection is high speed WLAN or low speed WWAN connection.

The packets reach the CS, and the Multiple PS Manager notes which PS the packet comes from and routes the packet to the CS Network Security & Sync-Seeking Peer Process. This process collects the packets, verifies the completion of reception of the e-mail, and sends the completion notification to the PS through the Multiple PS Manager that routes it to the correct PS.

Scenario 4: File Update from PS to CS where More than One PS Has Access to the File

There may be situations when an update from a PS affects a file or a data base record that others can access. In this case, the update from one PS would be distributed to the other affected PS's. This is a common situation in business usage.

In this case, the update from PS 1 should be distributed to PS 2 and PS 3 as well. The update from PS 1 arrives and works its way to the CS Data Management & File/DB Sync-Seeking System. The update is integrated with the affected data. Furthermore, the system notes that PS 2 and PS 3 have access to the affected data and initiates a send to PS 2 and PS 3 of the update. Further processing may occur to determine the version of file the changes apply to, and if the changed version is not the current version available to PS 2 and PS 3, then more sophisticated change management could be initiated—perhaps by alerting PS 1 to the problem. Considering the speed of the WIPSS POST protocol, the number of such update collisions is minimized.

6. File Locking

With disconnected devices, the user interface is complicated by the desire to modify files even though not connected to the enterprise. The WEPSS approach is to allow file modification without locking files by prompting the user to the extent possible. That is, WIPSS can tell the user what is known and what is unknown. (The alternative, locking files, is poor practice since a file may be locked by a user who becomes disconnected, and would remain locked for an extended time until the system timed-out. Also, the user is not aware that his/her changes were not applied to the file.)

Examples of notifications:
A. Providing continuous update to mobile workers that a certain file was last confirmed to be current as of X minutes ago (X=when the connection last existed and the CS reported current status);
B. If not currently in communication with the enterprise server, prompt for “Open as read-only?”
C. When reconnected, automatically check for changes on the enterprise end, and if necessary prompt “This file changed when you were disconnected. Present side-by-side?, or forward to file owner for resolution?, or save as is?”.

Despite this challenge, the user has the advantage of using familiar applications to access familiar files.

Practically speaking, a wireless update system cannot “lock” files or file segments (or records) like wire-line systems, because of the unreliability of wireless. One could lose a connection and the system would not recognize the fact for some time, preventing access by any other user.

7. PS Linked to More than One CS

Data is often fragmented, and systems incompatible. A CS that can handle data from one enterprise system may not be able, for security reasons, to handle the data from another enterprise system. CSs may need to be localized and adapted to handle the requirements of each enterprise system rather than being able to send all relevant sources of information to a single CS. Thus, there may be a clear need for any PS to be linked to more than one CS. Also, a user may be provided with a CS by his/her employer for business purposes, but the user may also want his/her personal files and/or multimedia files stored on their PS.

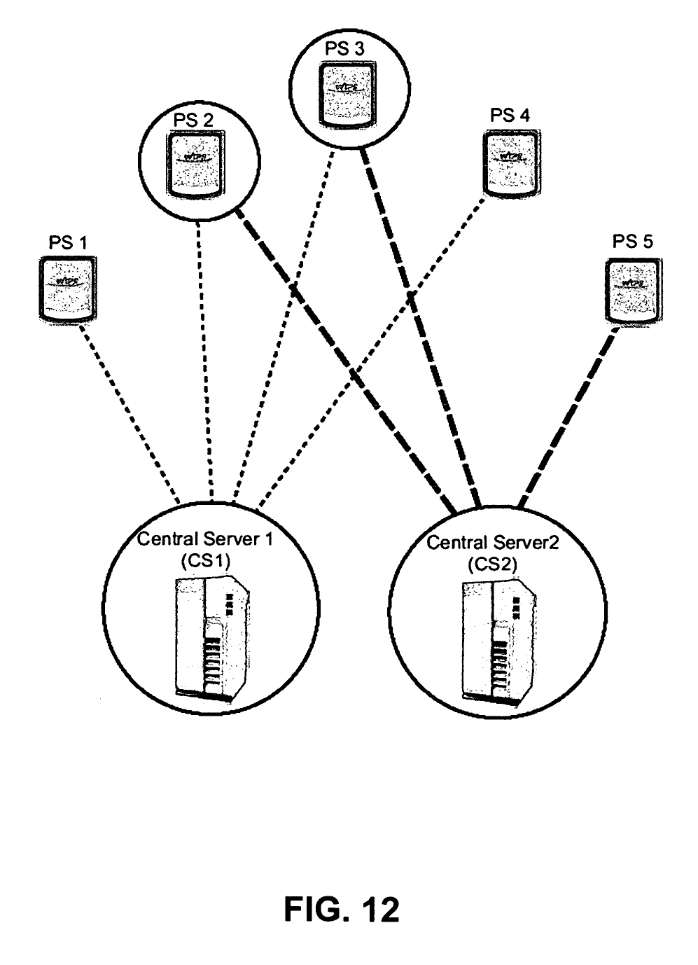

FIG. 12 (PS Linked to More Than One CS), shows a possible configuration of PS and CS units. The PS units that have been circled have two CS units linked to them.

Given that under these circumstances, the PS can be spoofed because the PS can be connected to more than one CS. Thus, the PS can attempt to authenticate every CS to which it is logically linked.

The fundamental system operation is similar to where the relationship between the CS and PS is 1:n. In this case, the relationship between the CS and PS is m:n. To perform this function, the PS adds a process with methods to handle multiple CS units.

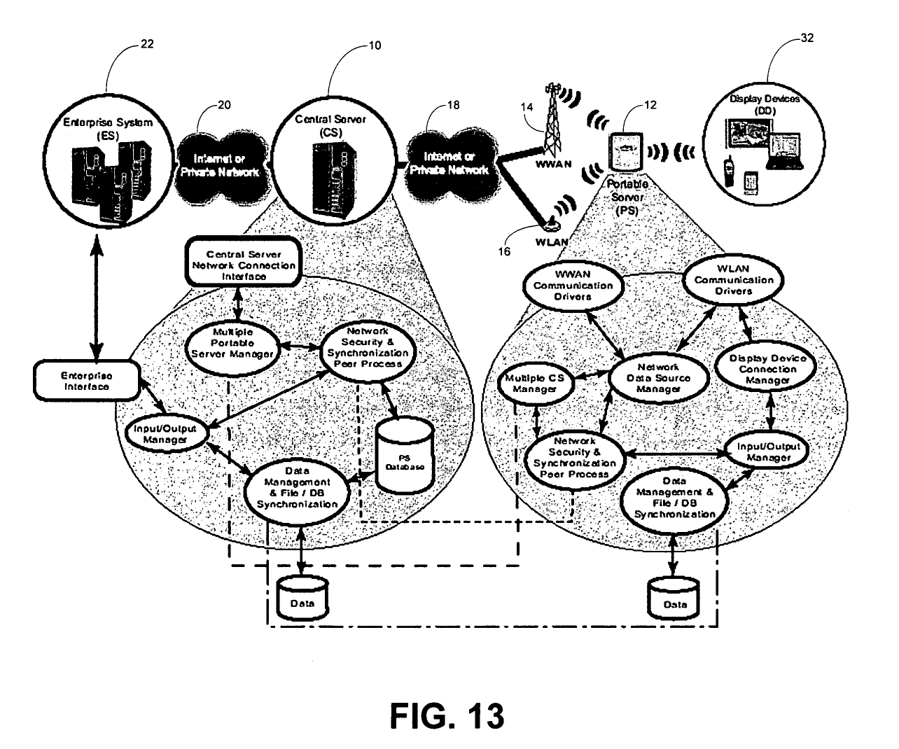

A Multiple CS Manager is added to the PS to manage the multiple CS units to which the PS has been logically linked. This is shown in FIG. 13 (Multiple CS Diagram). The Multiple CS Manager is logically linked to the Multiple PS Manager to enable mutual identification to insure that neither system can be spoofed.

The Data Management File/DB Sync-Seeking System on the PS has the same method of dealing with multiple CS systems as the CS has in dealing with multiple PS systems. On the PS, the files from each CS can be distinguished from each other because of the requirement of the logical identity between the files of the PS and CS.

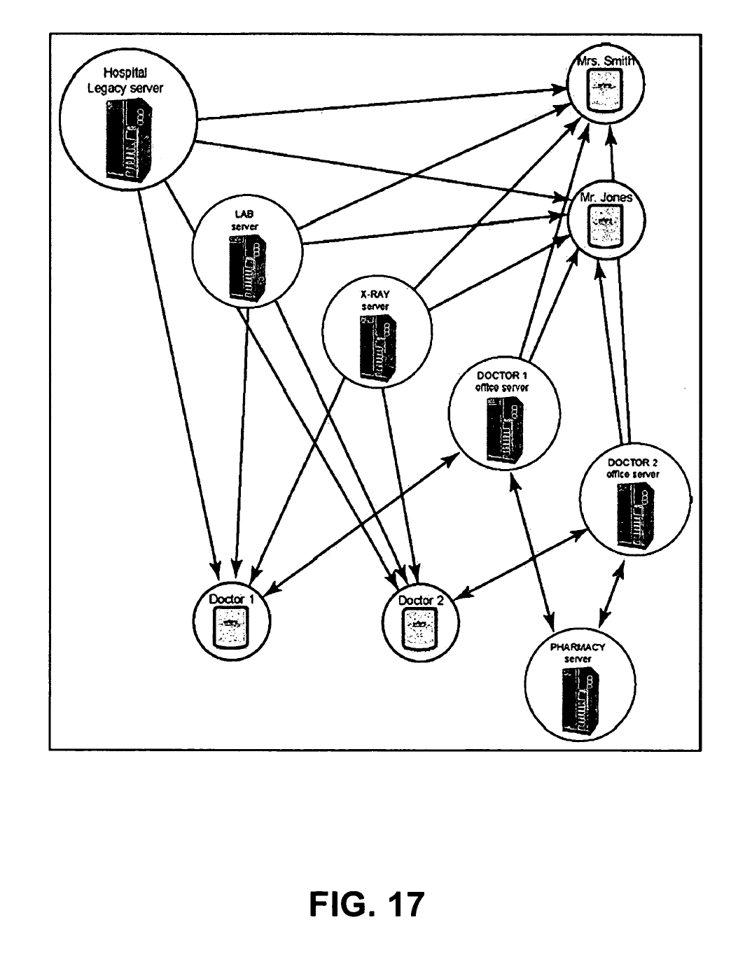

FIG. 17 (Access Simplified by “Central-Server” Consolidation of a User's Information Located on Multiple Legacy Systems) shows a practical medical application of various CSs accessing multiple legacy systems, so that patients have all their own records, and Doctors have all the information on their various patients. Although only one CS is shown for the patient named Mrs. Smith (for example), Mrs. Smith's PS might also access a different Central-Server for her business information, and possible a third CS for her family information.

8. Additional Embodiments

As noted in the original patent application, the PS can physically be integrated into a display device or a cell-phone type device. The services and the capabilities of the PS can be easily integrated into a display device. The display device could be a portable PC with a user interface and network connection capabilities to WLAN and/or a WWAN networks. Since the processes of the PS will be created using computer software, those same processes could be supported by software running on the portable PC/display device. This includes autonomous operation of the server. The operating system of the PC/display device can turn user interfaces off and on as needed and run only the Personal-Server software to save battery life, but still connect with the network(s), and possibly other display devices.

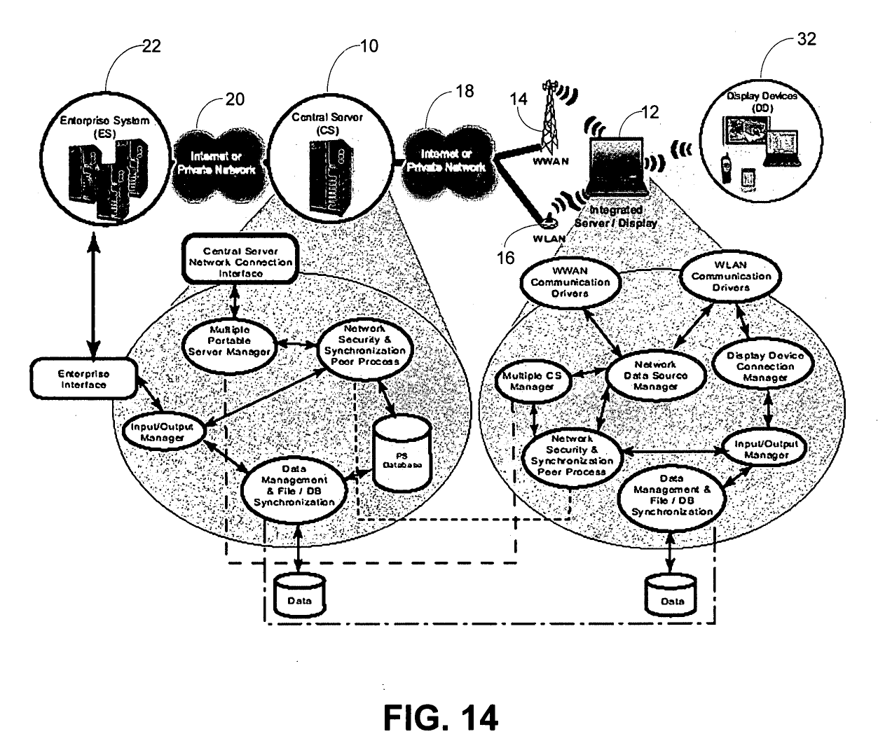

FIG. 14 (Portable-Server Integrated into Display Device) shows how PS system would be integrated into a portable PC. The diagram shows the PC hosting client and Portable-Server systems. The systems communicate preferably through the PC's operating system. The client system supports the inputs and outputs from and to the user. The server system handles the wireless connections to the network(s).

The PS appears to the user like any other server (office server). Depending upon the operating system the display device uses, the PS can determine the type of device used for display, and open files and display data in a manner to consistent with this device. Note that the Sync-Seeking server couplet can still serve up information to other display devices, despite the fact it is built into a display device. Also, this system will continue to be able to support e-mail.

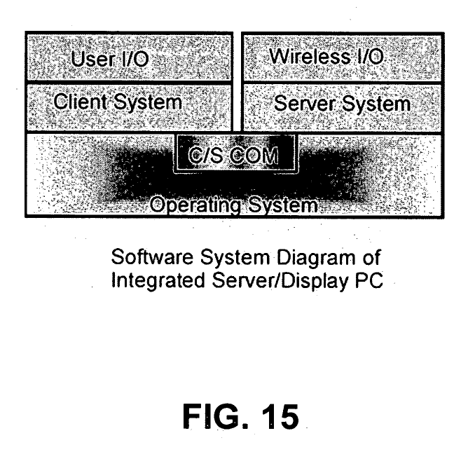

FIG. 15 (Software Integration) shows a conceptual diagram of how the server and the display device software would reside and communicate inside of the display device. The two sides would communicate through the data store. The data store acts as the cushion between the user and the “As-available” wireless network. Using the data store as the connection point does not restrict the user from “browsing the Web” with an Internet browser such as Opera or Netscape Navigator when the user has an active, high-speed connection. In fact, the server side of the system can automatically connect with an access point, thus eliminating the manual step of performing a manual connection.

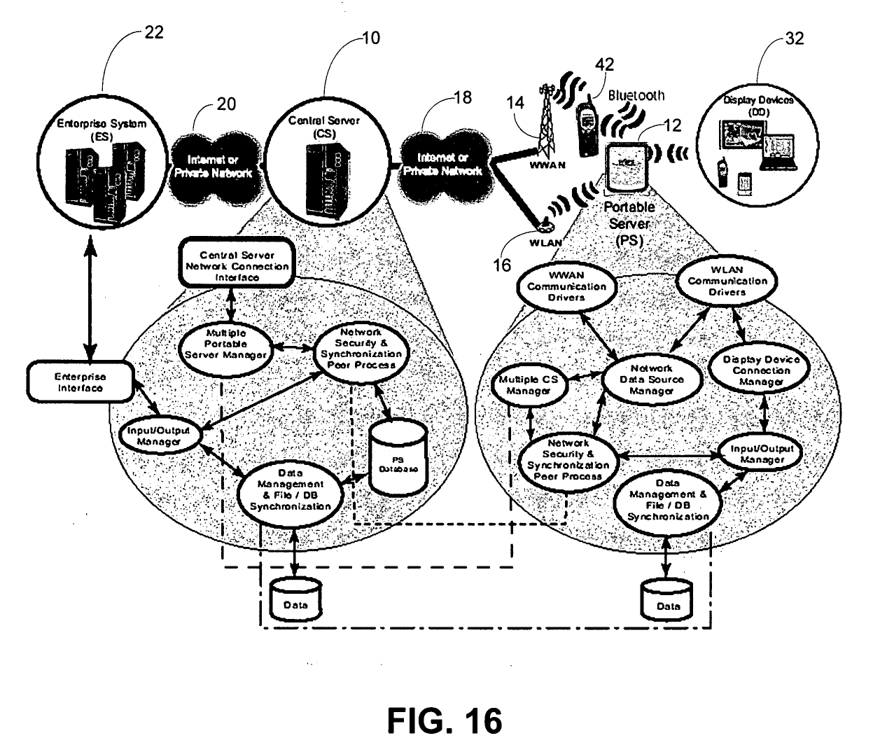

FIG. 16 (Using External Cell-phone) shows another embodiment specified in the original patent application. This embodiment, as discussed in the original patent application, is where the PS may not have its own WWAN communication facility, but rather uses its WLAN (or Bluetooth) facility to link to a nearby cell-phone (said cell-phone equipped with WLAN or Bluetooth), and the cell-phone serves as a WWAN wireless modem for the PS. This provides a lower cost, but less available, offering.

The cell-phone may have a built-in PDA display device, which the PS could provide services to over the same link.

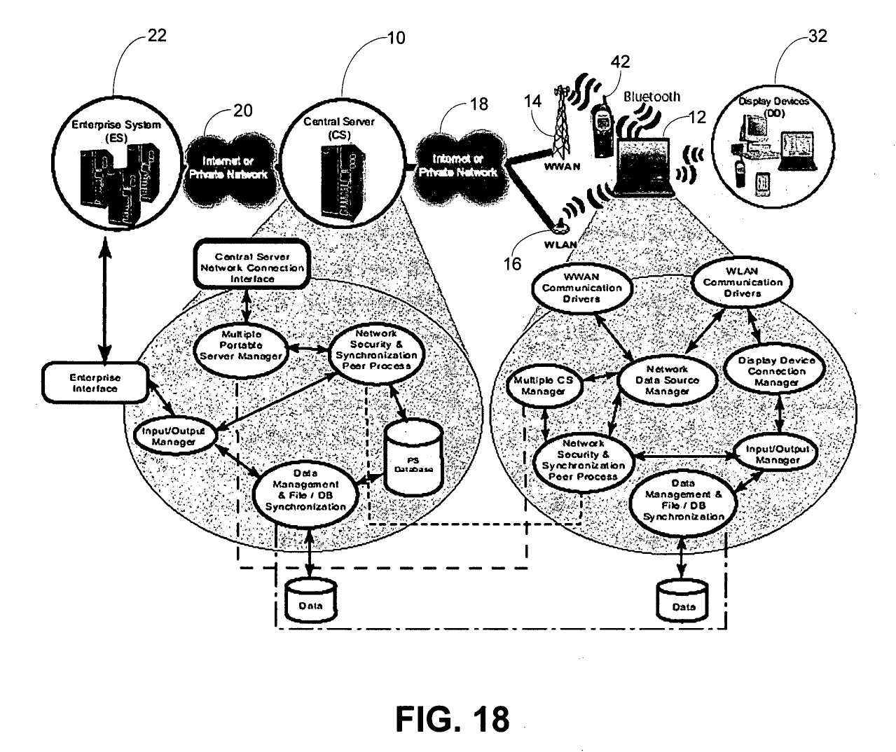

As noted above, the PS can be a stand-alone device or built into a display device. FIG. 18 (Using External Cell-phone and Integrated Server/Display Device) shows an embodiment in which the WIPSS is built into a display device and uses an external cell-phone.

Exemplary embodiments of the present invention have been described above. Those skilled in the art will understand, however, that changes and modifications may be made to these embodiments without departing from the true scope and spirit of the invention, which is defined by the claims.

1. A sync-seeking system, comprising:
a central server that stores a central-server copy of original data and can accumulate central-server changes to said central-server copy; and
a portable server that stores a portable-server copy of said original data and can accumulate portable-server changes to said portable-server copy,
wherein said central server and said portable server engage in peer-to-peer communication, via at least one wireless network, to exchange any central-server changes that have been accumulated by said central server and any portable-server changes that have been accumulated by said portable server until said central server and said portable server each store a copy of synchronized data.

2. The sync-seeking system of claim 1, wherein said synchronized data corresponds to said original data as modified by said any central-server changes and said any portable-server changes.

3. The sync-seeking system of claim 1, wherein said original data includes data records in a database.

4. The sync-seeking system of claim 1, wherein said original data includes data organized in a file system.

5. The sync-seeking system of claim 1, wherein said original data includes e-mail.

6. The sync-seeking system of claim 1, wherein said peer-to-peer communication includes said central server communicating at least one central-server change.

7. The sync-seeking system of claim 6, wherein said at least one central-server change includes additional data.

8. The sync-seeking system of claim 1, wherein said peer-to-peer communication includes said portable server communicating at least one portable-server change.

9. The sync-seeking system of claim 8, wherein said at least one portable-server change includes additional data.

10. The sync-seeking system of claim 1, wherein said central server is part of an enterprise system.

11. The sync-seeking system of claim 1, wherein said central server is communicatively coupled to an enterprise system via a network.

12. The sync-seeking system of claim 1, wherein said central server accumulates central-server changes to said central-server copy as a result of communication with an enterprise system.

13. The sync-seeking system of claim 1, wherein said central server accumulates central-server changes to said central-server copy as a result of communication with multiple enterprise systems, whereby said central server consolidates information from said multiple enterprise systems.

14. The sync-seeking system of claim 1, wherein said central server is accessible to a user via a web-based interface.

15. The sync-seeking system of claim 1, wherein said central server functions as a proxy to enable a user to access a private system.

16. The sync-seeking system of claim 1, wherein said central server impersonates a user to access information resources automatically.

17. The sync-seeking system of claim 1, wherein said portable server includes a display device connection manager that can interface said portable server to a display device.

18. The sync-seeking system of claim 17, wherein said display device connection manager can interface said portable server to different types of display devices.

19. The sync-seeking system of claim 17, wherein said display device connection manager can interface said portable server to said display device via a wireless link.

20. The sync-seeking system of claim 17, wherein said display device connection manager can interface said portable server to said display device to enable, after an authentication process, said display device to access data stored on said portable server.

21. The sync-seeking system of claim 20, wherein said portable server functions as a web proxy server to enable said display device to access cached web pages.

22. The sync-seeking system of claim 20, wherein said portable server impersonates an enterprise system to said display device.

23. The sync-seeking system of claim 17, wherein said portable server sends status information to said display device regarding said sync-seeking system.

24. The sync-seeking system of claim 23, wherein said status information includes information regarding when a given file was last confirmed to be current.

25. The sync-seeking system of claim 23, wherein said status information includes information that a given file has been changed.

26. The sync-seeking system of claim 23, wherein said status information includes information that a given file is currently being changed.

27. The sync-seeking system of claim 1, wherein said portable server is integrated into a display device.

28. The sync-seeking system of claim 1, wherein said portable server includes radio frequency (RF) resources for wirelessly communicating with said at least one wireless network.

29. The sync-seeking system of claim 1, wherein said portable server uses radio frequency (RF) resources in an external device for wirelessly communicating with said at least one wireless network.

30. The sync-seeking system of claim 29, wherein said external device is a cell phone.

31. The sync-seeking system of claim 1, wherein said at least one wireless network includes a wireless wide area network (WWAN).

32. The sync-seeking system of claim 31, wherein said portable server includes a network source manager that can communicate with said WWAN.

33. The sync-seeking system of claim 1, wherein said at least one wireless network includes a wireless local area network (WLAN).

34. The sync-seeking system of claim 33, wherein said portable server includes a network source manager that can communicate with said WLAN.

35. The sync-seeking system of claim 1, wherein said portable server includes a network source manager that tries to maintain a logical connection with said central server, via said at least one wireless network.

36. The sync-seeking system of claim 35, wherein said peer-to-peer communication occurs intermittently via said logical connection.

37. The sync-seeking system of claim 36, wherein said central server initiates said peer-to-peer communication, via said logical connection, in response to accumulating central-server changes to said original data.

38. The sync-seeking system of claim 36, wherein said portable server initiates said peer-to-peer communication, via said logical connection, in response to accumulating portable-server changes to said original data.

39. The sync-seeking system of claim 36, wherein said portable server periodically sends to said central server, via said logical connection, an indication that said portable server is connected and operational, when said central server and said portable server are not exchanging data.

40. The sync-seeking system of claim 35, wherein said network source manager selects at least one wireless communications channel for said logical connection, based on a selection algorithm.

41. The sync-seeking system of claim 40, wherein said network source manager selects a WLAN channel as an active communications channel and a WWAN channel as a standby communications channel.

42. The sync-seeking system of claim 40, wherein said network source manager selects a WWAN channel as an active communications channel and a WLAN channel as a standby communications channel.

43. The sync-seeking system of claim 40, wherein said network source manager selects both a WWAN channel and a WLAN channel as active communications channels in parallel.

44. The sync-seeking system of claim 35, wherein said network source manager tries to maintain a logical connection with said central server, via at least two wireless networks concurrently.

45. The sync-seeking system of claim 44, wherein said network source manager favors one of said at least two wireless networks based on selection criteria.

46. The sync-seeking system of claim 45, wherein said selection criteria are selected from the group consisting of immediacy of need, type of user need, speed, queue depth, and price.

47. The sync-seeking system of claim 1, wherein said peer-to-peer communication between said central server and said portable server occurs intermittently.

48. The sync-seeking system of claim 47, wherein said peer-to-peer communication uses as-available airtime of said at least one wireless network.

49. The sync-seeking system of claim 48, wherein using as-available airtime comprises separating messages into packets and sending said packets through said at least one wireless network during breaks in voice messages.

50. The sync-seeking system of claim 1, wherein said central server and said portable server can communicate in a real-time mode that uses on-demand airtime of said at least one wireless network.

51. The sync-seeking system of claim 50, wherein said central server and said portable server switch to said real-time mode for instant messaging.

52. The sync-seeking system of claim 51, wherein said central server logs into and out of an instant messaging server, on behalf of a user of said portable server.

53. The sync-seeking system of claim 52, wherein said central server enforces instant messaging policies.

54. The sync-seeking system of claim 1, wherein said central server and said portable server communicate using at least one diversity technique selected from the group consisting of time diversity, antenna diversity, network diversity, frequency diversity, and location diversity.

55. The sync-seeking system of claim 1, wherein said central server and said portable server communicate using at least three diversity techniques selected from the group consisting of time diversity, antenna diversity, network diversity, frequency diversity, and location diversity.

56. The sync-seeking system of claim 1, wherein said portable server tracks its own usage to generate portable-server-based billing information and reports said portable-server-based billing information to a billing facility.

57. The sync-seeking system of claim 56, wherein said central server generates central-server-based billing information regarding said portable server and reports said central-server-based billing information to said billing facility.

58. The sync-seeking system of claim 1, wherein said central server can initiate said peer-to-peer communication to erase data stored on said portable server.

59. A sync-seeking system, comprising:
a central server that stores a central-server copy of shared data and can accumulate central-server changes to said central-server copy;
a first portable server that stores a first-portable-server copy of said shared data and can accumulate first-portable-server changes to said first-portable-server copy; and
a second portable server that stores a second-portable-server copy of said shared data and can accumulate second-portable-server changes to said second-portable-server copy,
wherein said central server and said first portable server engage in peer-to-peer communication, via at least one wireless network, to exchange any central-server changes that have been accumulated by said central server and any first-portable-server changes that have been accumulated by said first portable server, and
said central server and said second portable server engage in peer-to-peer communication, via at least one wireless network, to exchange any central-server changes that have been accumulated by said central server and any second-portable-server changes that have been accumulated by said second portable server,
until said central server, said first portable server, and said second portable server each store a copy of synchronized data.

60. The sync-seeking system of claim 59, wherein said synchronized data corresponds to said shared data as modified by said any central-server changes, said any first-portable-server changes, and said any second-portable-server changes.

61. The sync-seeking system of claim 59, wherein said shared data includes data records in a database.

62. The sync-seeking system of claim 59, wherein said original data includes data organized in a file system.

63. The sync-seeking system of claim 59, wherein said shared data includes a transmission site knowledge base that contains information about locations for accessing specific wireless networks.

64. The sync-seeking system of claim 63, wherein said first portable server discovers additional information for inclusion in said transmission site knowledge base and accumulates said additional information as first-portable-server changes to said first-portable-server copy.

65. The sync-seeking system of claim 63, wherein said second portable server discovers additional information for inclusion in said transmission site knowledge base and accumulates said additional information as second-portable-server changes to said second-portable-server copy.

66. The sync-seeking system of claim 59, wherein said central server accumulates central-server changes to said central-server copy as a result of communication with an enterprise system.

67. The sync-seeking system of claim 59, wherein said central server accumulates central-server changes to said central-server copy as a result of communication with another central server.

68. The sync-seeking system of claim 59, wherein said central server accumulates central-server changes to said central-server copy as a result of communication with said first portable server.

69. The sync-seeking system of claim 59, wherein said central server accumulates central-server changes to said central-server copy as a result of communication with said second portable server.

70. The sync-seeking system of claim 59, wherein said first portable server accumulates first-portable-server changes to said first-portable-server copy as a result of communication with said central server.

71. The sync-seeking system of claim 59, wherein said first portable server accumulates first-portable-server changes to said first-portable-server copy as a result of communication with a display device.

72. The sync-seeking system of claim 59, wherein said second portable server accumulates second-portable-server changes to said second-portable-server copy as a result of communication with said central server.

73. The sync-seeking system of claim 59, wherein said second portable server accumulates second-portable-server changes to said second-portable-server copy as a result of communication with a display device.

74. A method for synchronizing a central server and a portable server, said method comprising:
said central server collecting central-server information for delivery to said portable server;
said portable server collecting portable-server information for delivery to said central server;
said portable server establishing a wireless connection with at least one wireless network;
said central server and said portable server establishing a logical connection via said at least one wireless network; and
said central server and said portable server engaging in peer-to-peer communication, via said logical connection, wherein said central server transfers said central-server information to said portable server and said portable server transfers said portable-server information to said central server.

75. The method of claim 74, further comprising:
said central server storing a central-server copy of original data; and
said portable server storing a portable-server copy of said original data.

76. The method of claim 75, wherein said central-server information includes changes to said central-server copy and said portable-server information includes changes to said portable-server copy.

77. The method of claim 74, further comprising:
said portable server searching for said at least one wireless network.

78. The method of claim 77, further comprising:
said portable server detecting said at least one wireless network.

79. The method of claim 74, further comprising:
said portable server selecting said at least one wireless network, based on a selection algorithm.

80. The method of claim 79, wherein said at least one wireless network includes a wireless wide area network (WWAN).

81. The method of claim 79, wherein said at least one wireless network includes a wireless local area network (WLAN).

82. The method of claim 79, wherein said at least one wireless network includes a WWAN and a WLAN.

83. The method of claim 82, wherein said portable server selects said WWAN as an active communications channel and selects said WLAN as a standby communications channel.

84. The method of claim 82, wherein said portable server selects said WLAN as an active communications channel and selects said WWAN as a standby communications channel.

85. The method of claim 74, wherein said central server and said portable server establishing a logical connection via said at least one wireless network comprises:
said portable server transmitting a portable-server network address to said central server.

86. The method of claim 85 wherein said portable-server network address is an IP address.

87. The method of claim 85, wherein said portable-server network address has been dynamically assigned to said portable server.

88. The method of claim 85, further comprising:
said central server receiving said portable-server network address; and
said central server verifying that said portable server is on a list of portable servers managed by said central server.

89. The method of claim 74, wherein said central server and said portable server establishing a logical connection via said at least one wireless network comprises:
said central server authenticating said portable server; and
said portable server authenticating said central server.

90. The method of claim 89, wherein said central server and said portable server authenticate each other using shared-secret data.

91. The method of claim 74, wherein said peer-to-peer communication is encrypted.

92. The method of claim 74, further comprising:
said portable server detecting that said wireless connection has been dropped and responsively attempting to re-establish said wireless connection with said at least one wireless network.

93. The method of claim 74, further comprising:
said portable server detecting that said wireless connection has been dropped and responsively attempting to establish a different wireless connection with a different wireless network.

94. The method of claim 74, further comprising:
said central server and said portable server maintaining said logical connection after said peer-to-peer communication is completed.

95. The method of claim 94, further comprising:
after said peer-to-peer communication is completed, said portable server periodically sending to said central server an indication that said portable server is connected and operational.

96. A sync-seeking system, comprising:
a portable server that stores a first-portable-server copy of first original data and a second-portable-server copy of second original data and can accumulate first-portable-server changes to said first-portable-server copy and second-portable-server changes to said second-portable-server copy;
a first central server that stores a first-central-server copy of said first original data and can accumulate first-central-server changes to said first-central-server copy; and
a second central server that stores a second-central-server copy of said second original data and can accumulate second-central-server changes to said second-central-server copy,
wherein said first central server and said portable server engage in peer-to-peer is communication, via at least one wireless network, to exchange any first-central-server changes that have been accumulated by said first central server and any first-portable-server changes that have been accumulated by said portable server until said first central server and said portable server each store a copy of first synchronized data that corresponds to said first original data as modified by said any first-central-server changes and said any first-portable-server changes, and
said second central server and said portable server engage in peer-to-peer communication, via at least one wireless network, to exchange any second-central-server changes that have been accumulated by said second central server and any second-portable-server changes that have been accumulated by said portable server until said second central server and said portable server each store a copy of second synchronized data that corresponds to said second original data as modified by said any second-central-server changes and said any second-portable-server changes.

97. The sync-seeking system of claim 96, wherein said first original data includes data organized in a file system.

98. The sync-seeking system of claim 96, wherein said second original data includes data organized in a file system.

99. The sync-seeking system of claim 96, wherein said first original data includes business-related data and said second original data includes personal data.

100. The sync-seeking system of claim 96, wherein said first central server accumulates first-central-server changes to said first-central-server copy as a result of communication with a first enterprise system.

101. The sync-seeking system of claim 100, wherein said second central server accumulates second-central-server changes to said second-central-server copy as a result of communication with a second enterprise system.
